(19) United States
(12) Patent Application Publication
(10) Pub. No.: US 2019/0199815 A1
(43) Pub. Date: Jun. 27, 2019

(54) METHOD AND APPARATUS FOR PROVIDING PROXY SERVICE VIA NAN PROXY SERVER IN WIRELESS COMMUNICATION SYSTEM

(71) Applicant: LG ELECTRONICS INC., Seoul (KR)

(72) Inventors: Hyunhee PARK, Seoul (KR); Dongcheol KIM, Seoul (KR); Byungjoo LEE, Seoul (KR); Giwon PARK, Seoul (KR); Youngjun JO, Seoul (KR); Taesung LIM, Seoul (KR)

(21) Appl. No.: 15/574,052

(22) PCT Filed: May 30, 2016
(86) PCT No.: PCT/KR2016/005689

§ 371 Date: Nov. 14, 2017

Related U.S. Application Data
(60) Provisional application No. 62/167,846, filed on May 28, 2015.
(60) Provisional application No. 62/172,819, filed on Jun. 9, 2015.
(60) Provisional application No. 62/193,572, filed on Jul. 16, 2015.

(51) Int. Cl. H04L 29/08; H04W 8/00; H04W 60/00; H04L 29/06

(52) U.S. Cl. CPC H04L 67/28; H04L 67/42; H04W 60/00; H04W 8/005

(57) ABSTRACT

The present specification relates to a method for performing discovery by a neighbor awareness networking (NAN) proxy server in a wireless communication system. The method for performing discovery by a proxy server may comprise: a step in which a NAN proxy client performs registration in a NAN proxy server; and a step in which the NAN proxy server performs discovery for a first service on behalf of the NAN proxy server client, wherein information for the first service is delivered to the NAN proxy server in the process of performing registration so as to be used in the discovery, and the discovery can be performed on the basis of the type of discovery.

### TECHNICAL FIELD

The present specification relates to a wireless communication system, and more particularly, to a method of providing a proxy service via a NAN proxy server in a wireless communication system.

### BACKGROUND ART

Wireless access systems have been widely deployed to provide various types of communication services such as voice or data. In general, a wireless access system is a multiple access system that may support communication of multiple users by sharing available system resources (e.g., a bandwidth, transmission power, etc.). For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a multi carrier frequency division multiple access (MC-FDMA) system.

Recently, various wireless communication technologies have been developed with the advancement of information communication technology. Among the wireless communication technologies, a wireless local area network (WLAN) is the technology capable of accessing the Internet by wireless in a home, a company or a specific service provided area through portable device such as a personal digital assistant (PDA), a laptop computer, a portable multimedia player (PMP), etc. based on a radio frequency technology.

### DISCLOSURE OF THE INVENTION

### Technical Tasks

One object of the present specification is to provide a method for a NAN proxy server to perform discovery in a wireless communication system and an apparatus therefor.

Another object of the present specification is to provide a method for a NAN proxy server to perform discovery on behalf of a NAN proxy client.

Another object of the present specification is to provide a method of differently performing discovery based on a discovery type when a NAN proxy server performs the discovery on behalf of a NAN proxy client.

The other object of the present specification is to provide a power saving function of a NAN proxy client based on a NAN proxy server.

### Technical Solution

According to an aspect of the present specification, provided herein a method of performing discovery performed by a NAN (neighbor awareness networking) proxy server in a wireless communication system, the method comprising: performing registration, by a NAN proxy client, at the NAN proxy server; and performing discovery, by the NAN proxy server, on a first service on behalf of the NAN proxy client, wherein information on the first service is delivered to the NAN proxy server in a process of performing the registration and is used for the discovery and wherein the discovery is performed based on a discovery type.

According to another aspect of the present specification, provided herein is a neighbor awareness networking (NAN) proxy server in a wireless communication system, comprising: a reception module configured to receive information from an external device; a transmission module configured to transmit information to an external device; and a processor configured to control the reception module and the transmission module, wherein the processor is further configured to: perform registration of a NAN proxy client, perform discovery on a first service on behalf of the NAN proxy client, wherein information on the first service is delivered to the NAN proxy server in a process of performing the registration and is used for the discovery and wherein the discovery is performed based on a discovery type.

The followings may be commonly applied to the method and NAN device for performing discovery with the proxy server in the wireless communication system.

In accordance with an embodiment of the present specification, the information on the first service comprises at least one of name information of the first service and device information of the NAN proxy client.

In accordance with an embodiment of the present specification, the NAN proxy server transmits a publish message containing a service discovery frame to a first NAN terminal when the discovery type corresponds to a first type.

In accordance with an embodiment of the present specification, the information on the first service is contained in the service discovery frame.

In accordance with an embodiment of the present specification, the first NAN terminal directly establishes a session with the NAN proxy client using the information on the first service contained in the service discovery frame when the publish type corresponds to a first type.

In accordance with an embodiment of the present specification, the NAN proxy server receives a subscribe message containing attribute information on the first NAN terminal from the first NAN terminal when the publish type corresponds to a second type.

In accordance with an embodiment of the present specification, a publish message containing the attribute information on the first NAN terminal is transmitted to the NAN proxy client when the NAN proxy server receives the subscribe message.

In accordance with an embodiment of the present specification, the publish message containing the attribute information on the first NAN terminal is exchanged in a discovery window in which the NAN proxy client is awaked.

In accordance with an embodiment of the present specification, the NAN proxy server receives a subscribe message containing attribute information on the first NAN terminal from the first NAN terminal when the discovery type corresponds to a second type.

In accordance with an embodiment of the present specification, the attribute information on the first NAN terminal comprises information on a second service.

In accordance with an embodiment of the present specification, the second service corresponds to a service to be used by the first NAN terminal.

In accordance with an embodiment of the present specification, the NAN proxy server transmits a publish message containing a service discovery frame to the first NAN terminal in response to the subscribe message when a subscribe type corresponds to a first type, and wherein the publish message is transmitted to the first NAN terminal only when the first service is matched with the second service.

In accordance with an embodiment of the present specification, the NAN proxy server transmits a publish message containing a service discovery frame to the NAN proxy client when a subscribe type corresponds to a second type, and wherein the publish message is transmitted to the NAN client only when the first service is matched with the second service.

### Advantageous Effects

According to the present specification, it is able to provide a method for a NAN proxy server to perform discovery in a wireless communication system and an apparatus therefor.

According to the present specification, it is able to provide a method for a NAN proxy server to perform discovery on behalf of a NAN proxy client.

According to the present specification, it is able to provide a method of differently performing discovery based on a discovery type when a NAN proxy server performs the discovery on behalf of a NAN proxy client.

According to the present specification, it is able to provide a power saving function of a NAN proxy client based on a NAN proxy server.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

FIG. 1 is a diagram for an example of a structure of IEEE 802.11 system;

FIGS. 2 to 3 are diagrams for examples of a NAN cluster;

FIG. 4 is a diagram for an example of a structure of a NAN terminal;

FIGS. 5 to 6 are diagrams illustrating a relation between NAN components;

FIG. 7 is a diagram illustrating a state transition of a NAN terminal;

FIG. 8 is a diagram illustrating a discovery window, and the like;

FIG. 9 is a diagram illustrating a discovery window;

FIG. 10 is a diagram illustrating a method for a NAN terminal to register the NAN terminal at a NAN proxy server as a NAN proxy client;

FIG. 11 is a diagram illustrating a method of discovering a NAN proxy service through a NAN proxy server;

FIG. 12 is a diagram illustrating a method of performing discovery;

FIG. 13 is a diagram illustrating a service discovery method performed in various types;

FIG. 14 is a diagram illustrating a method of establishing a session with a NAN proxy client after a NAN terminal is registered at a NAN proxy server;

FIG. 15 is a diagram illustrating a method for a NAN terminal to establish a session with a NAN proxy client;

FIG. 16 is a diagram illustrating a method for a NAN proxy server and a NAN proxy client to cancel registration;

FIG. 17 is a diagram illustrating a method of performing discovery based on an unsolicited publish type;

FIG. 18 is a diagram illustrating a method of performing discovery based on a solicited publish type;

FIG. 19 is a diagram illustrating a method of performing discovery based on a passive subscribe type;

FIG. 20 is a diagram illustrating a method of performing discovery based on an active subscribe type;

FIG. 21 is a flowchart for a method of providing a proxy service via a proxy server;

FIG. 22 is a block diagram for a terminal device.

### BEST MODE

### Mode for Invention

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide the full understanding of the present invention. However, it will be apparent to those skilled in the art that the present invention may be implemented without such specific details.

The following embodiments can be achieved by combinations of structural elements and features of the present invention in prescribed forms. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment.

Specific terminologies in the following description are provided to help the understanding of the present invention. And, these specific terminologies may be changed to other formats within the technical scope or spirit of the present invention.

Occasionally, to avoid obscuring the concept of the present invention, structures and/or devices known to the public may be skipped or represented as block diagrams centering on the core functions of the structures and/or devices. In addition, the same reference numbers will be used throughout the drawings to refer to the same or like parts in this specification.

The embodiments of the present invention can be supported by the disclosed standard documents disclosed for at least one of wireless access systems including IEEE 802 system, 3GPP system, 3GPP LTE system, LTE-A (LTE-Advanced) system and 3GPP2 system. In particular, the steps or parts, which are not explained to clearly reveal the technical idea of the present invention, in the embodiments of the present invention may be supported by the above documents. Moreover, all terminologies disclosed in this document can be supported by the above standard documents.

The following embodiments of the present invention can be applied to a variety of wireless access technologies, for example, CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented with such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc.

Although the terms such as “first” and/or “second” in this specification may be used to describe various elements, it is to be understood that the elements are not limited by such terms. The terms may be used to identify one element from another element. For example, a first element may be referred to as a second element, and vice versa within the range that does not depart from the scope of the present invention.

In the specification, when a part “comprises” or “includes” an element, it means that the part further comprises or includes another element unless otherwise mentioned. Also, the terms “ . . . unit”, “ . . . module” disclosed in the specification means a unit for processing at least one function or operation, and may be implemented by hardware, software or combination of hardware and software.

For clarity, the following description focuses on IEEE 802.11 systems. However, technical features of the present invention are not limited thereto.

[symbol]

### Structure of WLAN System

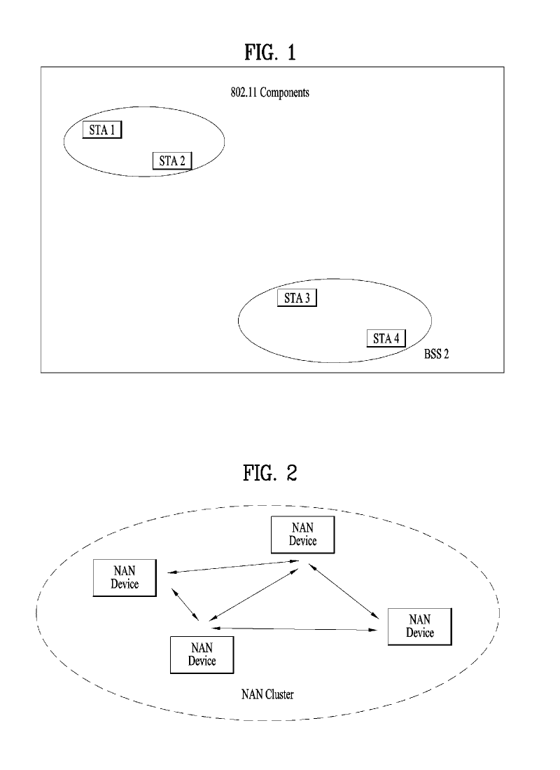

FIG. 1 is a diagram illustrating an exemplary structure of IEEE 802.11 system to which the present invention is applicable.

IEEE 802.11 structure may include a plurality of components and WLAN supportive of transparent STA mobility for an upper layer can be provided by interactions between the components. A basic service set (BSS) may correspond to a basic component block in IEEE 802.11 WLAN. FIG. 1 shows one example that two basic service sets BSS 1 and BSS 2 exist and that 2 STAs are included as members of each BSS. In particular, STA 1 and STA 2 are included in the BSS 1 and STA 3 and STA 4 are included in the BSS 2. In FIG. 1, an oval indicating the BSS can be understood as indicating a coverage area in which the STAs included in the corresponding BSS maintain communication. This area may be called a basic service area (BSA). Once the STA moves out of the BSA, it is unable to directly communicate with other STAs within the corresponding BSA.

A most basic type of BSS in IEEE 802.11 WLAN is an independent BSS (IBSS). For instance, IBSS can have a minimum configuration including 2 STAs only. Moreover, the BSS (e.g., BSS 1 or BSS 2) shown in FIG. 1, which has the simplest configuration and in which other components are omitted, may correspond to a representative example of the IBSS. Such a configuration is possible if STAs can directly communicate with each other. Moreover, the above-mentioned WLAN is not configured according to a devised plan but can be configured under the necessity of WLAN. And, this may be called an ad-hoc network.

If an STA is turned on/off or enters/escapes from a BSS area, membership of the STA in a BSS can be dynamically changed. In order to obtain the membership of the BSS, the STA can join the BSS using a synchronization procedure. In order to access all services of the BSS based structure, the STA should be associated with the BSS. This association may be dynamically configured or may include a use of a DSS (distribution system service).

Additionally, FIG. 1 shows components such as a DS (distribution system), a DSM (distribution system medium), an AP (access point) and the like.

In WLAN, a direct station-to-station distance can be restricted by PHY capability. In some cases, the restriction of the distance may be sufficient enough. However, in some cases, communication between stations located far away from each other may be necessary. In order to support extended coverage, the DS (distribution system) may be configured.

The DS means a structure in which BSSs are interconnected with each other. Specifically, the BSS may exist as an extended type of component of a network consisting of a plurality of BSSs instead of an independently existing entity as shown in FIG. 1.

The DS corresponds to a logical concept and can be specified by a characteristic of the DSM. Regarding this, IEEE 802.11 standard logically distinguishes a wireless medium (WM) from the DSM. Each of the logical media is used for a different purpose and is used as a different component. According to the definition of the IEEE 802.11 standard, the media are not limited to be identical to each other or to be different from each other. Since a plurality of the media are logically different from each other, flexibility of IEEE 802.11 WLAN structure (a DS structure or a different network structure) can be explained. In particular, the IEEE 802.11 WLAN structure can be implemented in various ways and the WLAN structure can be independently specified by a physical characteristic of each implementation case.

The DS can support a mobile device in a manner of providing seamless integration of a plurality of BSSs and logical services necessary for handling an address to a destination.

The AP enables associated STAs to access the DS through the WM and corresponds to an entity having STA functionality. Data can be transferred between the BSS and the DS through the AP. For instance, as shown in FIG. 1, while each of the STA 2 and STA 3 have STA functionality, the STA 2 and STA 3 provide functions of enabling associated STAs (STA 1 and STA 4) to access the DS. And, since all APs basically correspond to an STA, all APs correspond to an addressable entity. An address used by the AP for communication in the WM should not be identical to an address used by the AP for communication in the DSM.

Data transmitted from one of STAs associated with an AP to an STA address of the AP is always received in an uncontrolled port and the data can be processed by an IEEE 802.1X port access entity. Moreover, if a controlled port is authenticated, transmission data (or frame) can be delivered to a DS.

[symbol]

### Layer Structure

Operations of the STA which operates in a wireless LAN system can be explained in terms of the layer structure. In terms of a device configuration, the layer structure can be implemented by a processor. The STA may have a structure of a plurality of layers. For example, a main layer structure handled in the 802.11 standard document includes a MAC sublayer and a physical (PHY) layer on a data link layer (DLL). The PHY layer may include a physical layer convergence procedure (PLCP) entity, a physical medium dependent (PMD) entity, etc. The MAC sublayer and the PHY layer conceptually include management entities called MAC sublayer management entity (MLME) and physical layer management entity (PLME), respectively. These entities provide a layer management service interface for performing a layer management function.

A station management entity (SME) is present within each STA in order to provide an accurate MAC operation. The SME is a layer-independent entity that may be considered as existing in a separate management plane or as being off to the side. Detailed functions of the SME are not specified in this document but it may be generally considered as being responsible for functions of gathering layer-dependent status from the various layer management entities (LMEs), setting values of layer-specific parameters similar to each other. The SME may perform such functions on behalf of general system management entities and may implement a standard management protocol.

The aforementioned entities interact with each other in various ways. For example, the entities may interact with each other by exchanging GET/SET primitives. The primitive means a set of elements or parameters related to a specific purpose. XX-GET.request primitive is used for requesting a value of a given MIB attribute (management information based attribute). XX-GET.confirm primitive is used for returning an appropriate MIB attribute value if a status is ‘success’, otherwise it is used for returning an error indication in a status field. XX-SET.request primitive is used to request that an indicated MIB attribute be set to a given value. If this MIB attribute implies a specific action, this requests that the action be performed. And, XX-SET.confirm primitive is used such that, if the status is ‘success’, this confirms that the indicated MIB attribute has been set to the requested value, otherwise it is used to return an error condition in the status field. If this MIB attribute implies a specific action, this confirms that the action has been performed.

Moreover, the MLME and the SME may exchange various MLME_GET/SET primitives through an MLME SAP (service access point). Furthermore, various PLME_GET/SET primitives may be exchanged between the PLME and the SME through PLME_SAP and may be exchanged between the MLME and the PLME through an MLME-PLME_SAP.

[symbol]

### NAN (Neighbor Awareness Network) Topology

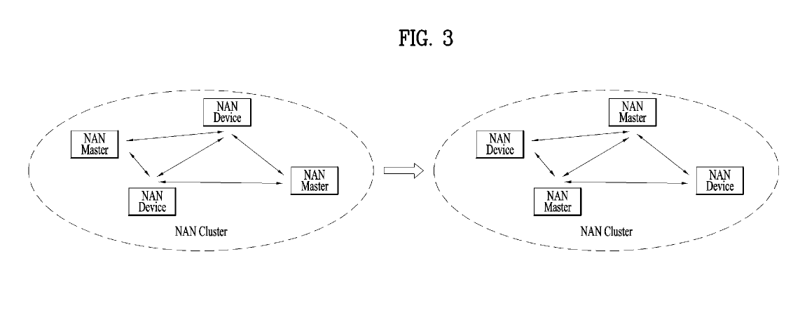

A NAN network can be constructed with NAN devices (devices) that use a set of identical NAN parameters (e.g., a time interval between consecutive discovery windows, an interval of a discovery window, a beacon interval, a NAN channel, etc.). A NAN cluster can be formed by NAN devices and the NAN cluster means a set of NAN devices that are synchronized on the same discovery window schedule. And, a set of the same NAN parameters is used in the NAN cluster. FIG. 2 illustrates an example of the NAN cluster. A NAN device included in the NAN cluster may directly transmit a multicast/unicast service discovery frame to a different NAN device within a range of the discovery window. As shown in FIG. 3, at least one NAN master may exist in a NAN cluster and the NAN master may be changed. Moreover, the NAN master may transmit all of a synchronization beacon frame, discovery beacon frame and service discovery frame.

[symbol]

### NAN Device Architecture

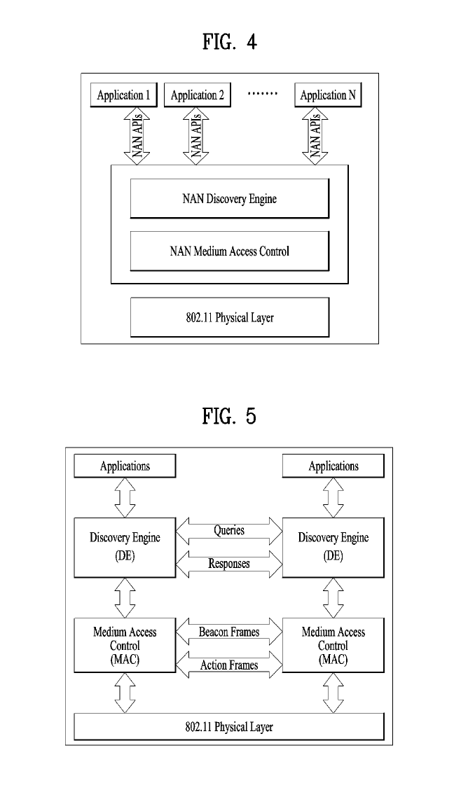

FIG. 4 illustrates an example of a structure of a NAN device (device). Referring to FIG. 4, the NAN device is based on a physical layer in 802.11 and its main components correspond to a NAN discovery engine, a NAN MAC (medium access control), and NAN APIs connected to respective applications (e.g., Application 1, Application 2, . . . , Application N).

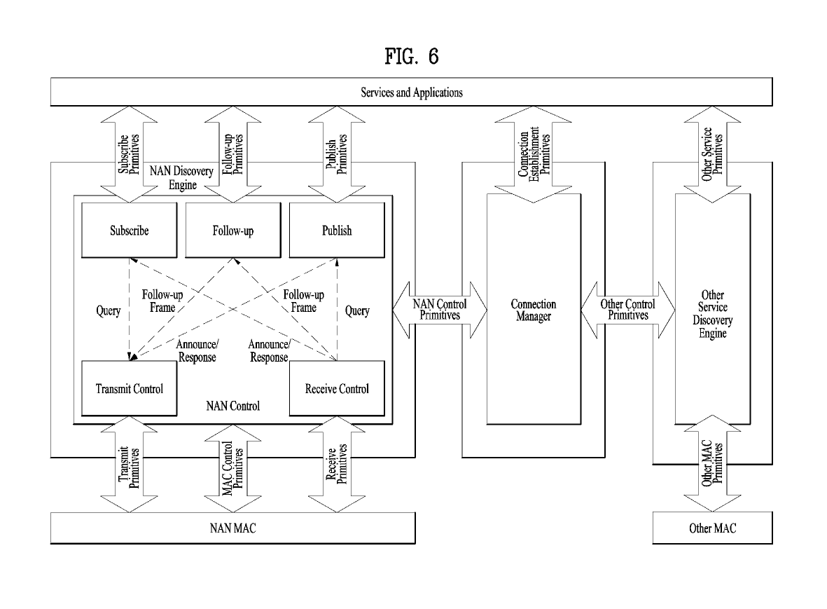

FIGS. 5 and 6 illustrate relations between NAN components. Service requests and responses are processed through the NAN discovery engine, and the NAN beacon frames and the service discovery frames are processed by the NAN MAC. The NAN discovery engine may provide functions of subscribing, publishing, and following-up. The publish/subscribe functions are operated by services/applications through a service interface. If the publish/subscribe commands are executed, instances for the publish/subscribe functions are generated. Each of the instances is driven independently and a plurality of instances can be driven simultaneously in accordance with the implementation. The follow-up function corresponds to means for the services/applications that transceive specific service information.

[symbol]

### Role and State of NAN Device

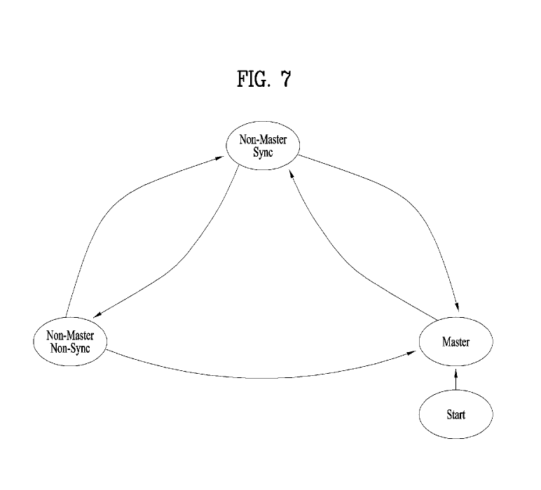

As mentioned in the foregoing description, a NAN device (device) can serve as a NAN master and the NAN master can be changed. In other words, roles and states of the NAN device can be shifted in various ways and related examples are illustrated in FIG. 7. The roles and states, which the NAN device can have, may include a master (hereinafter, the master means a state of master role and sync), a Non-master sync, and a Non-master Non-sync. Transmission availability of the discovery beacon frame and/or the synchronization beacon frame can be determined according to each of the roles and states and it may be set as illustrated in Table 1.

TABLE 1

| Role and State | Discovery Beacon | Synchronization Beacon |
|---|---|---|
| Master | Transmission Possible | Transmission Possible |
| Non-Master | Transmission | Transmission Possible |
| Sync | Impossible | |
| Non-Master | Transmission | Transmission |
| Non-Sync | Impossible | Impossible |

The state of the NAN device can be determined according to a master rank (MR). The master rank indicates the preference of the NAN device to serve as the NAN master. In particular, a high master rank means strong preference for the NAN master. The NAN MR can be determined by Master Preference, Random Factor, Device MAC address, and the like according to Formula 1.

MasterRank=MasterPreference*2⁵⁶+RandomFactor*2⁴⁸+MAC[5]*2⁴⁰+ . . . +MAC[0] [Formula 1]

In Formula 1, the Master Preference, Random Factor, Device MAC address may be indicated through a master indication attribute. The master indication attributes may be set as illustrated in Table 2.

TABLE 2

| Field Name | Size (Octets) | Value | Description |
|---|---|---|---|
| Attribute ID | 1 | 0x00 | Identifies the |
| | | | type of NAN attribute. |
| Length | 2 | 2 | Length of the |
| | | | following field in the |
| | | | attribute |
| Master | 1 | 0-255 | Information |
| Preference | | | that is used to indicate a |
| | | | NAN Device's |
| | | | preference to serve as the |
| | | | role of Master, with a |
| | | | larger value indicating a |
| | | | higher preference. |
| Random Factor | 1 | 0-255 | A random |
| | | | number selected by the |
| | | | sending NAN Device. |

[symbol]

Regarding the above MR, in case of a NAN device that activates a NAN service and initiates a NAN cluster, each of the Master Preference and the Random Factor is set to 0 and NANWarmUp is reset. The NAN device should set a Master Preference field value in the master indication attribute to a value greater than 0 and a Random Factor value in the master indication attribute to a new value until when the NANWarmUp expires. When a NAN device joins a NAN cluster in which the Master Preference of an anchor master is set to a value greater than 0, the corresponding NAN device may set the Master Preference to a value greater than 0 and the Random Factor to a new value irrespective of expiration of the NANWarmUp.

Moreover, a NAN device can become an anchor master of a NAN cluster depending on an MR value. That is, all NAN devices have capabilities of operating as the anchor master. The anchor master means the device that has a highest MR and a smallest AMBTT (anchor master beacon transmit time) value and has a hop count (HC) (to the anchor master) set to 0 in the NAN cluster. In the NAN cluster, two anchor masters may exist temporarily but a single anchor master is a principle of the NAN cluster. If a NAN device becomes an anchor master of a currently existing NAN cluster, the NAN device adopts TSF used in the currently existing NAN cluster without any change.

The NAN device can become the anchor master in the following cases: if a new NAN cluster is initiated; if the master rank is changed (e.g., if an MR value of a different NAN device is changed or if an MR value of the anchor master is changed); or if a beacon frame of the current anchor master is not received any more. In addition, if the MR value of the different NAN device is changed or if the MR value of the anchor master is changed, the NAN device may lose the status of the anchor master. The anchor master can be determined according to an anchor master selection algorithm in the following description. In particular, the anchor master selection algorithm is the algorithm for determining which NAN device becomes the anchor master of the NAN cluster. And, when each NAN device joins the NAN cluster, the anchor master selection algorithm is driven.

If a NAN device initiates a new NAN cluster, the NAN device becomes the anchor master of the new NAN cluster. If a NAN synchronization beacon frame has a hop count in excess of a threshold, the NAN synchronization beacon frame is not used by NAN devices. And, other NAN synchronization beacon frames except the above-mentioned NAN synchronization beacon frame are used to determine the anchor master of the new NAN cluster.

If receiving the NAN synchronization beacon frame having the hop count equal to or less than the threshold, the NAN device compares an anchor master rank value in the beacon frame with a stored anchor master rank value. If the stored anchor master rank value is greater than the anchor master value in the beacon frame, the NAN device discards the anchor master value in the beacon frame. If the stored anchor master value is less than the anchor master value in the beacon frame, the NAN device newly stores values greater by 1 than the anchor master rank and the hop count included in the beacon frame and an AMBTT value in the beacon frame. If the stored anchor master rank value is equal to the anchor master value in the beacon frame, the NAN device compares hop counters. Then, if a hop count value in the beacon frame is greater than a stored value, the NAN device discards the received beacon frame. If the hop count value in the beacon frame is equal to (the stored value−1) and if an AMBTT value is greater than the stored value, the NAN device newly stores the AMBTT value in the beacon frame. If the hop count value in the beacon frame is less than (the stored value−1), the NAN device increases the hop count value in the beacon frame by 1. The stored AMBTT value is updated according to the following rules. If the received beacon frame is transmitted by the anchor master, the AMBTT value is set to the lowest four octets of time stamp included in the received beacon frame. If the received beacon frame is transmitted from a NAN master or non-master sync device, the AMBTT value is set to a value included in a NAN cluster attribute in the received beacon frame.

Meanwhile, a TSF timer of a NAN device exceeds the stored AMBTT value by more than 16*512 TUs (e.g., 16 DW periods), the NAN device may assume itself as an anchor master and then update an anchor master record. In addition, if any of MR related components (e.g., Master Preference, Random Factor, MAC Address, etc.) is changed, a NAN device not corresponding to the anchor master compares the changed MR with a stored value. If the changed MR of the NAN device is greater than the stored value, the corresponding NAN device may assume itself as the anchor master and then update the anchor master record.

Moreover, a NAN device may set anchor master fields of the cluster attributes in the NAN synchronization and discovery beacon frames to values in the anchor master record, except that the anchor master sets the AMBTT value to a TSF value of corresponding beacon transmission. The NAN device, which transmits the NAN synchronization beacon frame or the discovery beacon frame, may be confirmed that the TSF in the beacon frame is derived from the same anchor master included in the cluster attribute.

Moreover, a NAN device may adopt a TSF timer value in a NAN beacon received with the same cluster ID in the following case: i) if the NAN beacon indicates an anchor master rank higher than a value in an anchor master record of the NAN device; or ii) if the NAN beacon indicates an anchor master rank equal to the value in the anchor master record of the NAN device and if a hop count value and an AMBTT value in the NAN beacon frame are larger values in the anchor master record.

[symbol]

### NAN Synchronization

NAN devices (devices) participating in the same NAN Cluster may be synchronized with respect to a common clock. A TSF in the NAN cluster can be implemented through a distributed algorithm that should be performed by all the NAN devices. Each of the NAN devices participating in the NAN cluster may transmit NAN synchronization beacon frame (NAN sync beacon frame) according to the above-described algorithm. The NAN device may synchronize its clock during a discovery window (DW). A length of the DW corresponds to 16 TUs. During the DW, one or more NAN devices may transmit synchronization beacon frames in order to help all NAN devices in the NAN cluster synchronize their own clocks.

NAN beacon transmission is distributed. A NAN beacon frame is transmitted during a DW period existing at every 512 TU. All NAN devices can participate in generation and transmission of the NAN beacon according to their roles and states. Each of the NAN devices should maintain its own TSF timer used for NAN beacon period timing. A NAN synchronization beacon interval can be established by the NAN device that generates the NAN cluster. A series of TBTTs are defined so that the DW periods in which synchronization beacon frames can be transmitted are assigned exactly 512 TUs apart. Time zero is defined as a first TBTT and the discovery window starts at each TBTT.

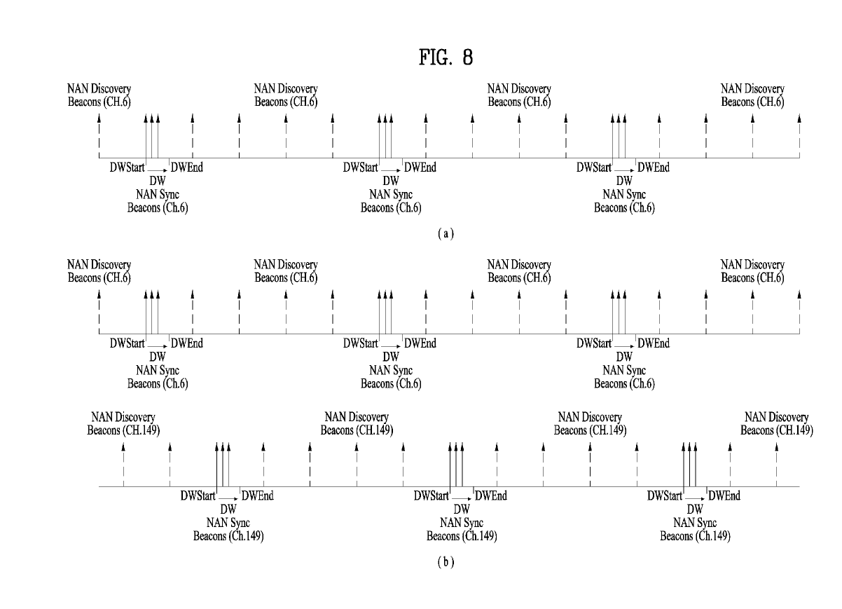

Each NAN device serving as a NAN master transmits a NAN discovery beacon frame from out of a NAN discovery window. On average, the NAN device serving as the NAN master transmits the NAN discovery beacon frame every 100 TUs. A time interval between consecutive NAN discovery beacon frames is smaller than 200 TUs. If a scheduled transmission time overlaps with a NAN discovery window of the NAN cluster in which the corresponding NAN device participates, the NAN device serving as the NAN master is able to omit transmission of the NAN discovery beacon frame. In order to minimize power required to transmit the NAN discovery beacon frame, the NAN device serving as the NAN master may use AC_VO (WMM Access Category—Voice) contention setting. FIG. 8 illustrates relations between a discovery window and a NAN discovery beacon frame and transmission of NAN synchronization/discovery beacon frames. Particularly, FIG. 8 (a) shows transmission of NAN discovery and synchronization beacon frames of a NAN device operating in 2.4 GHz band. FIG. 8 (b) shows transmission of NAN discovery and synchronization beacon frames of a NAN device operating in 2.4 GHz and 5 GHz bands.

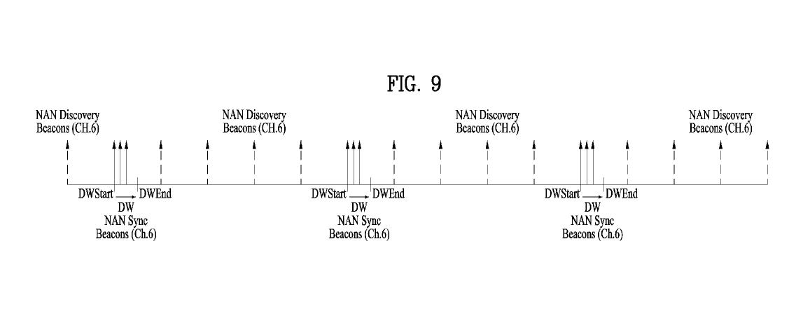

FIG. 9 is a diagram illustrating a discovery window. As mentioned in the foregoing description, each NAN terminal performing a master role transmits a synchronization beacon frame within a discovery window and transmits a discovery beacon frame at the outside of the discovery window. In this case, as mentioned in the foregoing description, the discovery window can be repeated in every 512 TU. In this case, duration of the discovery window may correspond to 16 TUs. In particular, the discovery window can last during 16 TUs. In this case, for example, all NAN terminals belonging to a NAN cluster may awake at every discovery window to receive a synchronization beacon frame from a master NAN terminal. By doing so, the NAN cluster can be maintained. In this case, if all NAN terminals awake at every discovery window in a fixed manner, power consumption of the terminals may get worse. Hence, it is necessary to have a method of reducing power consumption by dynamically controlling duration of a discovery window while synchronization is maintained in a NAN cluster.

For example, as mentioned in the foregoing description, a NAN terminal may operate in 2.4 GHz band or 5 GHz band. As a different example, a NAN terminal may operate in sub 1 GHz band. For example, a NAN terminal can be configured to support IEEE 802.11ah that supports sub 1 GHz band. For example, if a NAN terminal supports 900 MHz, it may have link quality and a physical model different from link quality and a physical model in 2.4 GHz or 5 GHz.

For example, if a NAN terminal supports 900 MHz, the NAN terminal can send a signal farther and perform communication in a wider range. In this case, data communication can be performed between NAN terminals and data can be exchanged between NAN terminals. In this case, since the data exchange is performed based on the data communication, a problem may exist in efficiently managing power in the NAN terminal. In order to solve the problem, it may differently configure a method of configuring a discovery window period. FIG. 9 shows a basic structure that a synchronization beacon frame is transmitted within a discovery window and a discovery beacon frame is transmitted at the outside of the discovery window. The basic structure can also be similarly applied to a NAN terminal supporting 900 MHz band.

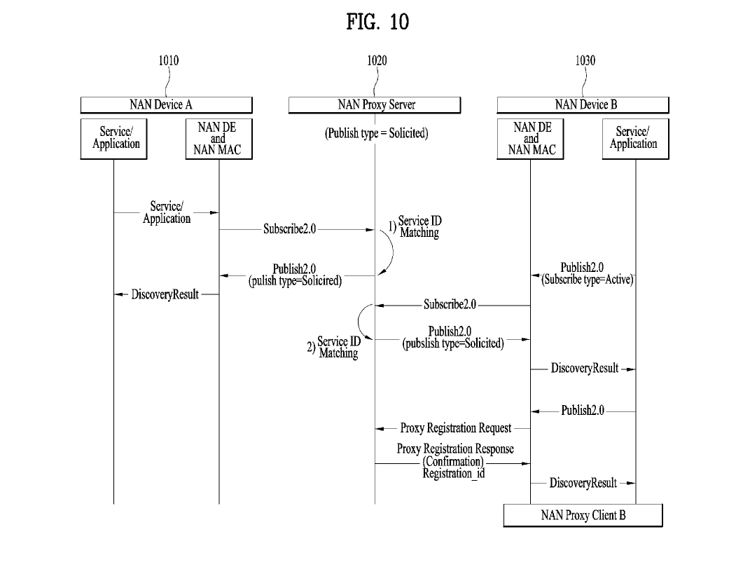

FIG. 10 is a diagram illustrating a method for a NAN terminal to register the NAN terminal at a NAN proxy server as a NAN proxy client.

As mentioned in the foregoing description, NAN terminals can perform data communication. A NAN terminal can receive a frame in a manner of being awaken in a discovery window. In this case, if the NAN terminal performs a procedure for performing data communication in a manner of being awaken in all discovery windows, considerable amount of power can be consumed.

Hence, in the following, a method of reducing power consumption of a NAN terminal is explained. For example, a NAN proxy terminal can be defined as a new role (concept) of the NAN terminal. For example, the NAN proxy terminal may correspond to a NAN proxy server or a NAN proxy client. In this case, the NAN proxy server can perform a procedure for performing data communication on behalf of the NAN proxy client. For example, the NAN proxy server can perform publish and/or subscribe on behalf of the NAN proxy client. More specifically, the NAN proxy server can provide information, which is provided to perform data communication with a different NAN terminal, to other NAN terminals on behalf of the NAN proxy client. In particular, the NAN proxy server can perform the procedure for performing data communication on behalf of the NAN proxy client to reduce power consumption of the NAN proxy client.

For example, the NAN proxy server may correspond to a terminal not sensitive to power consumption. And, the NAN proxy client may correspond to a terminal operating based on low power. In this situation, similar to a legacy NAN terminal, if the NAN proxy client awakes in every discovery window, since the NAN proxy client consumes a considerable amount of power, it may be difficult to use the NAN proxy client. Hence, it may make a terminal not sensitive to power consumption perform a procedure for performing data communication on behalf of the NAN proxy client to reduce power consumption and efficiently perform the data communication.

In this case, in order for the NAN proxy server to perform the procedure for performing the data communication on behalf of the NAN proxy client, it is necessary for the NAN proxy server to obtain information on the NAN proxy client. To this end, the NAN proxy client can be registered at the NAN proxy server. In the following, a method of registering the NAN proxy client at the NAN proxy server is described.

More specifically, a NAN terminal playing a role of a proxy server may correspond to a NAN proxy server. In this case, for example, the NAN proxy server can provide other NAN terminals with information indicating that the NAN proxy server is able to operate as a NAN proxy server. For example, the NAN proxy server can include information on a NAN proxy server role in a broadcasted message. In this case, other NAN terminals can identify the NAN proxy server based on the broadcasted message. And, for example, the NAN proxy server can provide other NAN terminals with the information on the NAN proxy server role using a publish message, by which the present invention may be non-limited.

If NAN terminals 1010/1030 recognize the NAN proxy server, the NAN terminals 1010/1030 can transmit a subscribe message to the NAN proxy server 1020 to find out a service of the NAN proxy server 1020.

More specifically, as mentioned in the foregoing description, the NAN terminals 1010/1030 may have a layered structure. In this case, for example, a service/application layer of a first NAN terminal (NAN device A, 1010) can provide a discovery engine (DE) and NAN MAC of the first NAN terminal 1010 with a subscribe method.

In this case, for example, primitives of the subscribe method provided to the NAN DE and the NAN MAC layers by the service/application layer can be represented as Table 3 in the following. In particular, the service/application layer can provide information on Table 3 to the NAN DE and the NAN MAC layers. More specifically, the service/application layer can provide information on a service name, service specific information, and a configuration parameter to be searched by a NAN terminal to the NAN DE and the NAN MAC layers.

And, other additional information can also be included in the primitives of the subscribe method, by which the present invention may be non-limited.

TABLE 3
Subscribe(service_name, service_specific_info,
configuration_parameters)

service_name:

UTF-8 name string which identifies the service/application

service_specific_info:

Sequence of values which further specify the published
service beyond

the service name

configuration_parameters

Subscribe type

Active

Query period
Recommended periodicity of query transmissions
Time to live

The instance of the Subscribe function can be commanded to run for
a

given time interval or until the first DiscoveryResult event

[symbol]

Subsequently, the first NAN terminal 1010 can transmit a subscribe message to the NAN proxy server 1020. In particular, the first NAN terminal 1010 can transmit the subscribe message to the NAN proxy server 1020 based on the subscribe method as an active subscribe.

Subsequently, when the NA proxy server 1020 replies to the subscribe message, the NAN proxy server 1020 can transmit a publish message to the first NAN terminal 1010 by matching a service ID with a service capable of being provided by the NAN proxy server 1020. In this case, a Publish Type of the publish message may correspond to Solicited.

In this case, for example, the service/application layer of the NAN proxy server 1020 can provide a publish method to the NAN DE and NAN MAC layers of the NAN proxy server 1020. In this case, for example, primitives of the publish method can be represented as follows.

In particular, the service/application layer can provide information on Table 4 to the NAN DE and the NAN MAC layers. More specifically, the service/application layer can provide information on a service name, service specific information, and a configuration parameter supported by the NAN proxy server 1020 to the NAN DE and the NAN MAC layers.

In this case, Publish type information can be included in configuration information to indicate that solicited transmission is performed. And, Solicited transmission type information can also be included in the configuration information to indicate whether or not the solicited transmission corresponds to unicast transmission or broadcast transmission. And, Time to live information can be included in the configuration information as information on time during which a publish function is performed. And, Event conditions information can be included in the configuration information to indicate whether or not an event is generated.

And, other additional information can also be included in the primitives of the publish method, by which the present invention may be non-limited.

TABLE 4
Publish(service_name, service_specific_info,
configuration_parameters)

service_name:

UTF-8 name string which identifies the service/application

service_specific_info:

Sequence of values which should be conveyed to the Discovery
Engine of

a NAN Device that has invoked a Subscribe method corresponding to this
Publish method.

configuration_parameters

Publish type:

Solicited transmissions only

Solicited transmission type:

Determines whether a solicited transmission is a
unicast or a

broadcast transmission

Time to live:

The instance of the Publish function can be
commanded to run for a

given time interval or for one transmission only

Event conditions:

Determines when Publish related events are generated.
Events can be

requested to be generated on each solicited transmission. Alternatively, no
events are expected.

[symbol]

Subsequently, if the first NAN terminal 1010 receives a publish message, the NAN DE and the NAN MAC layers of the first NAN terminal 1010 can provide a discovery result as an event to the service/application layer of the first NAN terminal 1010. By doing so, the first NAN terminal 1010 can complete the service discovery of the NAN proxy server 1020.

In this case, for example, primitives of the discovery result event can be represented as Table 5 in the following.

More specifically, the NAN DE and the NAN MAC layers can provide the service/application layer with the discovery result event including subscribe id information that identifies a subscribe function, service_specific_info information corresponding to specific service information supported by the NAN proxy server, publish_id information corresponding to publish ID information, and Address information corresponding to address information of the proxy server.

And, other additional information can also be included in the primitives of the discovery result event, by which the present invention may be non-limited.

TABLE 5
DiscoveryResult(subscribe_id, service_{—}
specific_info, publish_id, address)

subscribe_id:

As originally returned by the instance of the Subscribe function

service_specific_info:

Sequence of values which were decoded from a frame received
from the

Proxy server

publish_id:

Identifier for the instance of the published service on a remote
Proxy

server

Address:

NAN Interface Address of the Proxy Server

[symbol]

And, the second NAN terminal (NAN device B, 1030) can discover a service of the NAN proxy server 1020 based on a method identical to the method of the first NAN terminal 1010. In this case, for example, the service discovery on the NAN proxy server 1020 can be individually performed by each of the NAN terminals 1010/1030.

In this case, for example, having completed the service discovery on the NAN proxy server 1020, a service/application layer of the second NAN terminal 1030 can provide a publish method to NAN DE and NAN MAC layers of the second NAN terminal 1030.

In this case, for example, primitives used for the second NAN terminal 1030 to register at the NAN proxy server can be defined as Table 6 and Table 7 in the following. More specifically, the service/application layer of the second NAN terminal 1030 can provide information on proxy registration to the NAN DE and the NAN MAC layers of the second NAN terminal 1030 according to Table 6 and Table 7 as a publish method. In particular, the second NAN terminal 1030 can provide the information on the proxy registration to the NAN DE and the NAN MAC layers of the second NAN terminal 1030 by reusing a legacy publish method and a subscribe method. In this case, for example, when the legacy publish method and the subscribe method are reused, information for registering at the proxy server rather than information of the second NAN terminal for publishing the second NAN terminal 1030 can be included in a service_specific_info field. In particular, the second NAN terminal 1030 may use a method of including the information on the registration by using the legacy publish method and the subscribe method formats as it is.

TABLE 6
Publish (service_name, service_specific_info,
configuration_parameters)

service_name:

UTF-8 name string which identifies the service/application

service_specific_info:

Sequence of values which should be conveyed to the Discovery
Engine of

a NAN Device that has invoked a Subscribe method corresponding to this
Publish method.

configuration_parameters

Publish type:

Solicited transmissions only and Unsolicited
transmission only

Solicited transmission type:

Determines whether a solicited transmission is a
unicast or a

broadcast transmission

Announcement period:

Recommended periodicity of unsolicited transmissions

Time to live:

The instance of the Publish function can be
commanded to run for a

given time interval or for one transmission only

Event conditions:

Determines when Publish related events are generated.
Events can be

requested to be generated on each solicited transmission. Alternatively, no
events are expected.

[symbol]

TABLE 7
Subscribe (service_name, service_specific_info,
configuration_parameters)

service_name:

UTF-8 name string which identifies the service/application

service_specific_info:

Sequence of values which should be conveyed to the
Discovery Engine of

a NAN Device that has invoked a Subscribe method corresponding to this
Publish method.

configuration_parameters

Subscribe type:

Determines the type of Subscribe as follows

| Passive: | NAN device can passively subscribe to |
|---|---|
| | internal NAN DE. |
| Active: | NAN device can actively subscribe to |

proxy server.

Discovery range:

Determines whether the service is searched in close
proximity only

or in any NAN Devices within range

Query period:

Recommended periodicity of query transmissions

Time to live:

The instance of the Subscribe function can be
commanded to run for

a given time interval or until the first DiscoveryResult eventRecommended
periodicity of unsolicited transmissions

[symbol]

As a different example, the second NAN terminal 1030 can newly define and use primitives for a method called for registration. In particular, the service/application layer of the second NAN terminal 1030 can provide information on proxy registration by providing a newly defined proxy registration method to the NAN DE and the NAN MAC layers of the second NAN terminal 1030. In this case, primitives of the newly defined proxy registration method can be represented as Table 8 in the following.

TABLE 8
ProxyRegistartion(service_name, service_specific_info,
configuration_parameters)

service_name:

UTF-8 name string which identifies the service/application

service_specific_info:

Sequence of values which should be conveyed to the Discovery
Engine of a

NAN Device that has invoked a Subscribe method corresponding to this
ProxyRegistration method.

configuration_parameters

ProxyRegistration type:

Solicited transmissions only and Unsolicited
transmission

Solicited transmission type:

Determines whether a solicited transmission is a
unicast or a

broadcast transmission

Announcement period:

Recommended periodicity of unsolicited transmissions

Time to live:

The instance of the Publish function can be
commanded to run for a

given time interval or for one transmission only

Event conditions:

Determines when ProxyRegistration related events are
generated.

Events can be requested to be generated on each solicited transmission.
Alternatively, no events are expected.

[symbol]

In particular, the service/application layer of the second NAN terminal 1030 can provide a method for registering at the NAN proxy server to the NAN DE and the NAN MAC. In this case, the method may correspond to a method using a legacy publish method format and the method including information on proxy registration. And, for example, the method may correspond to a method newly defined for proxy registration, by which the present invention may be non-limited.

Subsequently, the NAN DE and the NAN MAC layers of the second NAN terminal 1030 can transmit a proxy registration request to the NAN proxy server 1020. In this case, the proxy registration request may correspond to a publish message. For example, the proxy registration request may correspond to a publish type as a service discovery frame. In this case, a service discovery attribute for the proxy registration request can be represented as Table 9 in the following.

TABLE 9

| | Size | Value | |
|---|---|---|---|
| Field | (Octets) | (Hex) | Description |
| Attribute ID | 1 | 0x03 | Identifies the type of NAN |
| | | | attribute |
| Length | 2 | Variable | Length of the following |
| | | | fields in the attribute. |
| Service ID | 6 | Variable | Mandatory field that |
| | | | contains the hash of the |
| | | | Service Name. |
| Instance ID | 1 | Variable | Publish_ID or Subscribe_ID |
| Requestor | 1 | Variable | Instance ID from the frame |
| Instance ID | | | that triggered the |
| | | | transmission if available, |
| | | | otherwise set to 0x00. |
| Service | 1 | Variable | Mandatory field that |
| Control | | | defines the Service Control |
| | | | bitmap |
| Binding Bitmap | 0 or 2 | 0x0000 | Optional field that |
| | | to0xFF FF | indicates the binding of |
| | | | the SDA to post discovery |
| | | | connection attributes |
| Service | 0 or 1 | Variable | An optional field and |
| Response | | | present if a service |
| Filter Length | | | response filter is used. |
| Service | Variable | Variable | An optional field that |
| Response | | | identifies the matching |
| Filter | | | service response filters |
| Service Info | 0 or 1 | Variable | An optional field and |
| Length | | | present if service specific |
| | | | information is used |
| Service Info | Variable | Variable | An optional field that |
| | | | contains the service |
| | | | specific information. Its |
| | | | content may be determined |
| | | | by the application and not |
| | | | specified herein. |

In this case, for example, a service ID field can be mandatorily included in fields described in the following included in the proxy registration request. In this case, the service ID field can be defined by a proxy service ID corresponding to a service provided by the NAN proxy server. And, a proxy registration request field can include information necessary for a NAN terminal to register at the NAN proxy server. In this case, for example, a service info field corresponding to a field included in the proxy registration request can include a proxy request TLV (proxy registration request TLV). In this case, the proxy request TLV can be represented as Table 10 in the following. In this case, for example, the proxy request TLV can include an availability time field indicating DW duration during which a NAN terminal awakes after being registered as a proxy client. And, the proxy request TLV can also include a service ID field corresponding to an ID of a service requested by the NAN terminal to the NAN proxy server. Besides, the proxy request TLV can also include information necessary for the NAN terminal to register at the NAN proxy server, by which the present invention may be non-limited.

TABLE 10

| | Size | Value | |
|---|---|---|---|
| Field | (Octets) | (Hex) | Description |
| Type | 1 | Variable | Type code of the Proxy |
| | | | Registration Request TLV |
| Length | 2 | Variable | Length of Proxy |
| | | | Registration Request TLV |
| | | | (not including the Type and |
| | | | Length fields) |
| Availability | 1 | Variable | Indicates bitmap for the DW |
| Time | | | Awake Duration of Proxy |
| | | | Client (DW could be |
| | | | presented from DW0 to DW15 |
| | | | with bitmap pattern) |
| | | | If bitmap bit is set as 0, |
| | | | Proxy Client is sleep, |
| | | | otherwise bitmap bit is set |
| | | | as 1, Proxy Client is |
| | | | awake, eg., when DW awake |
| | | | duration is DW1 and DW2, |
| | | | bitmap is presented as |
| | | | 011000000000000. |
| Time to live | 1 | Variable | Indicates TTL of Proxy |
| | | | Client's service |
| service ID | 6 | Variable | Indicates the requesting |
| | | | servive ID |
| Instance ID | 1 | Variable | Publish_ID or Subscribe_ID |
| Requestor | 1 | Variable | Instance ID from the frame |
| Instance ID | | | that triggered the |
| | | | transmission if available, |
| | | | otherwise set to 0x00 |
| Service | 1 | Variable | Mandatory field that |
| Control | | | defines the Service Control |
| | | | bitmap |
| Binding | 0 or 2 | 0x0000 | Optional field that |
| Bitmap | | to 0xFF FF | indicates the binding of |
| | | | the SDA to post discovery |
| | | | connection attributes |
| Service | 0 or 1 | Variable | An optional field and |
| Response | | | present if a service |
| Filter Length | | | response filter is used. |
| Service | Variable | Variable | An optional field that |
| Response | | | identifies the matching |
| Filter | | | service response filters |
| Service Info | 0 or 1 | Variable | An optional field and |
| Length | | | present if service specific |
| | | | information is used |
| Service Info | Variable | Variable | An optional field that |
| | | | contains the service |
| | | | specific information. Its |
| | | | content may be determined |
| | | | by the application and not |
| | | | specified herein. |

[symbol]

Subsequently, the NAN proxy server can transmit a proxy response to the second NAN terminal 1030 in response to the proxy request. In this case, for example, the proxy response may correspond to a publish message. For example, the proxy registration response corresponds to a service discovery frame having a publish type. In this case, for example, a service discovery attribute for the proxy registration response can be represented as the aforementioned Table 9.

In this case, for example, a service ID field may correspond to a field mandatorily included in the fields described in the following included in the proxy registration response. In this case, the service ID field can be defined by a proxy service ID corresponding to a service provided by the NAN proxy server. The proxy registration response field can also include information necessary for a NAN terminal to register at the NAN proxy server. In this case, a service info field corresponding to a field included in the proxy registration response can include a proxy response TLV (proxy registration response TLV). In this case, the proxy response TLV can be represented as Table 11 in the following. In this case, for example, the proxy response TLV can include a status indication field indicating whether or not the NAN proxy server permits the registration of a NAN terminal. In this case, for example, if the status indication field corresponds to 0, it may indicate that the NAN proxy server permits the registration of the NAN terminal. And, if the status indication field corresponds to 1 or 2, it may indicate that the registration is denied base on a different reason. And, for example, the proxy response TLV can include a registration ID field indicating a registration ID. And, the proxy response TLV can include a service ID field corresponding to an ID of a service provided by the NAN proxy server. Besides, the NAN proxy response TLV can include information necessary for a NAN terminal to register at the NAN proxy server, by which the present invention may be non-limited.

TABLE 11

| | Size | Value | |
|---|---|---|---|
| Field | (Octets) | (Hex) | Description |
| Type | 1 | Variable | Type code of the Proxy |
| | | | Registration Request TLV |
| Length | 2 | Variable | Length of Proxy |
| | | | Registration Request TLV |
| | | | (not including the Type and |
| | | | Length fields) |
| Status | 1 | Variable | If set to 0, Proxy |
| indication | | | registration is accept, |
| | | | otherwise set to 1 is fail |
| | | | due to requested |
| | | | information not available, |
| | | | and set to 2 is fail due to |
| | | | bad request |
| Registration | 1 | Variable | Indicates the Registration |
| ID | | | ID of requested service |
| MAC Address of | 6 | Variable | Indicates the MAC Address |
| matched device | | | of matched device on a |
| | | | remote NAN Device |
| service ID | 6 | Variable | Responses the requesting |
| | | | servive ID |
| Time to live | 1 | Variable | Indicates TTL of Proxy |
| | | | Server |
| Watchdog timer | 1 | Variable | Indicates Watchdog timer |
| | | | value |

Subsequently, if the NAN DE and the NAN MAC of the second NAN terminal 1030 receive a confirmation from the NAN proxy server, the NAN DE and the NAN MAC of the second NAN terminal 1030 can provide a discovery result event to the service/application layer. In this case, for example, if a proxy response of which the status indication field corresponds to 1 is received, it may indicate that a confirmation is completed. Subsequently, the second NAN terminal 1030 may become a NAN proxy client registered at the NAN proxy server based on the discovery result event.

A NAN terminal may become a NAN proxy client registered at the NAN proxy server via the aforementioned procedure.

As mentioned in the foregoing description, it may be able to support a mechanism for performing data transmission of NAN terminals or reducing power consumption using the NAN proxy server. In this case, for example, when two NAN terminals are unable to perform communication due to a distance between the two NAN terminals, the terminals can perform communication using the NAN proxy server. And, since it is not necessary for a NAN proxy client to awake in every discovery window, it may be able to reduce power consumption.

In this case, the NAN terminal can perform a service discovery of the NAN proxy server by transmitting a subscribe message to the NAN proxy server. In this case, in order for the NAN terminal to transmit the subscribe message to the NAN proxy server, it is necessary to identify the NAN proxy server. In particular, it is necessary for the NAN terminal to check the existence of the NAN proxy server.

In this case, for example, the NAN proxy server can inform the NAN terminal of the existence of the NAN proxy server by publishing a service discovery frame by broadcasting the service discovery frame. In this case, for example, the publishing may correspond to a solicited type or an unsolicited type, by which the present invention may be non-limited.

For example, in order for the NAN proxy server to inform the NAN terminal of the capability of the NAN proxy server, the NAN proxy server can add a proxy server attribute within a NAN beacon frame or a service discovery frame. In this case, among NAN terminals, which have received the NAN beacon frame or the service discovery frame including the proxy server attribute, a terminal supporting a proxy client function interprets the proxy server attribute and may be then able to check the existence of the proxy server located near the terminal.

More specifically, Table 12 shows NAN attribute information capable of being included in the beacon frame and the service discovery frame. In this case, in Table 12, an attribute ID field can be defined by a different value to indicate a different attribute. And, for example, each of the attribute information may or may not be included in the beacon frame and the service discovery frame. And, for example, specific attribute information among the attribute information can be mandatorily included (represented by “M” in the table) in the beacon frame and the service discovery frame or can be optionally included (represented by “O” in the table) in the beacon frame and the service discovery frame.

In this case, it may be able to define at least one of a proxy server attribute field and a proxy client attribute field using a reserved bit belonging to the fields of the NAN attribute information. In this case, for example, the proxy server attribute field can be included in at least one selected from the group consisting of a NAN synchronization beacon frame, a NAN discovery beacon frame, and a NAN service discovery frame. In particular, the proxy server attribute field corresponds to a field defined by the NAN proxy server to notify the existence of the NAN proxy server. The proxy server attribute field can be selectively included in each of the frames.

On the contrary, the proxy client attribute field can be selectively included in the service discovery frame. In particular, the proxy client attribute field may correspond to information transmitted by a NAN terminal based on whether or not the NAN proxy server exists and whether or not the NAN terminal becomes a NAN proxy client. Hence, the proxy client attribute field is not transmitted to a NAN beacon frame and can be transmitted in a manner of being included in a NAN service discovery window.

TABLE 12

| Attribute | | NAN Beacons | | |
|---|---|---|---|---|
| ID | Description | Sync | Discovery | NAN SDF |
| 0 | Master Indication | YES/M | YES/M | NO |
| | Attribute | | | |
| 1 | Cluster Attribute | YES/M | YES/M | NO |
| 2 | Service ID List Attribute | YES/O | YES/O | NO |
| 3 | Service Descriptor | NO | NO | YES/M |
| | Attribute | | | |
| 4 | NAN Connection | NO | NO | YES/O |
| | Capability Attribute | | | |
| 5 | WLAN Infrastructure | NO | NO | YES/O |
| | Attribute | | | |
| 6 | P2P Operation Attribute | NO | NO | YES/O |
| 7 | IBSS Attribute | NO | NO | YES/O |
| 8 | Mesh Attribute | NO | NO | YES/O |
| 9 | Further NAN Service | NO | NO | YES/O |
| | Discovery Attribute | | | |
| 10 | Further Availability Map | NO | NO | YES/O |
| | Attribute | | | |
| 11 | Country Code Attribute | YES/O | YES/O | YES/O |
| 12 | Ranging Attribute | NO | NO | YES/O |
| 13 | Cluster Discovery | NO | NO | NO |
| | Attribute¹ | | | |
| 14 (TBD) | Proxy Server Attribute | YES/O | YES/O | YES/O |
| 15 (TBD | Proxy Client Attribute | NO | NO | YES/O |
| 16-220 | Reserved | NA | NA | NA |
| 221 | Vendor Specific Attribute | YES/O | YES/O | YES/O |
| 222-255 | Reserved | NA | NA | NA |

¹Cluster Discovery Attribute is intended to be carried in any Beacon frame other than a NAN Beacon and Probe Response frames.

In this case, the proxy server attribute field can be configured as Table 13 in the following. More specifically, the proxy server attribute field can include a proxy server address field including address information of a NAN interface of a proxy server. And, the proxy server attribute field can include a proxy server capability field as information on capability of the NAN proxy server. In this case, a function of the NAN proxy server can be included in a bitmap form. And, an awake interval of the NAN proxy server can be represented by a value of an integer form. In this case, the integer value corresponds to a discovery window period during which the NAN proxy server is awaked. In particular, if the integer value corresponds to 1, the NAN proxy server can awake in every discovery window period. In this case, for example, since the NAN proxy server plays a role of the NAN proxy client on behalf of the NAN proxy client, it is preferable that the NAN proxy server awakes in every discovery window.

And, for example, if it is necessary to reduce power consumption of the NAN proxy server, it may change the integer value, by which the present invention may be non-limited. If the NAN proxy server provides a function of an AP STA at the same time, it may include a BSSID field as the AP STA.

TABLE 13

| | Size | | |
|---|---|---|---|
| Field | (Octets) | Value | Description |
| Attribute ID | 1 | 0x14 | Identifies the type of NAN |
| | | | attribute (TBD) |
| Length | 2 | Variable | Length of the following |
| | | | fields in the attribute. |
| Proxy Server | 6 | Variable | NAN Interface address of |
| | | | NAN Proxy Server |
| Proxy Server | 1 | Variable | Capability of Proxy Server |
| Capability | | | |
| Awake Interval | 1 | 1-255 | DW Interval of this Proxy |
| | | | Server |
| BSSID | 6 | Variable | BSSID which is support by |
| | | | Proxy Service if capable |

And, a bitmap for the proxy server capability field can be represented as Table 14 in the following. More specifically, a publish proxy bit of the proxy server capability bitmap can indicate whether or not the NAN proxy server is able to transmit a service publish, which is proxied by receiving a publish request from a neighboring NAN terminal.

And, a subscribe proxy bit can indicate whether or not the NAN proxy server searches for a neighboring service by receiving a subscribe request from a neighboring NAN terminal and whether or not the NAN proxy server informs a NAN terminal of the searched service. And, a follow-up proxy bit can indicate whether or not a function of proxying a follow-up service discovery window of a neighboring NAN terminal is available. And, an invite proxy bit indicates whether or not a function of asking neighboring NAN terminals to participate in BSS of an AP STA of the NAN proxy server is available. And, a NAN data path can indicate whether or not the NAN proxy server supports a NAN data path function. And, a NAN data forwarding bit can indicate whether or not a function of receiving a NAN data path from a NAN terminal and forwarding the NAN data path to neighboring NAN terminals is available. In particular, the proxy server capability field can indicate information on the functions capable of being performed by the NAN proxy server, by which the present invention may be non-limited.

TABLE 14

| Bit(s) | Information | Notes |
|---|---|---|
| 0 | Publish Proxy | Publish Proxy bit shall be |
| | | set, if a Proxy server |
| | | supports Proxy a Publish |
| | | request form Proxy client, |
| | | and is set to 0 otherwise. |
| 1 | Subscribe Proxy | Subscribe Proxy bit shall be |
| | | set, if a Proxy server |
| | | supports Proxy a Subscribe |
| | | request form Proxy client, |
| | | and is set to 0 otherwise. |
| 2 | follow-up Proxy | follow-up bit shall be set, |
| | | if a Proxy server supports |
| | | Proxy a follow-up request |
| | | form Proxy client, and is set |
| | | to 0 otherwise. |
| 3 | Invite Proxy | follow-up bit shall be set, |
| | | if a Proxy server supports to |
| | | invite other NAN device to |
| | | its own BSS, and is set to 0 |
| | | otherwise. |
| 4 | NAN Data Path | NAN Data Path bit shall be |
| | | set, if a Proxy server |
| | | supports to NAN data path |
| | | capability, and is set to 0 |
| | | otherwise. |
| 5 | NAN Data Forwarding | NAN Data Forwarding bit shall |
| | | be set, if a Proxy server |
| | | supports to NAN data |
| | | Forwarding from NAN device |
| | | other, and is set to 0 |
| | | otherwise. |
| 6 | Reserved | — |

As a different example, the proxy server attribute field can be configured as Table 15 in the following. In this case, for example, a previously registered NAN proxy client may exist in the NAN proxy server. In particular, information on a registered NAN proxy client can be included in the proxy server attribute field. In this case, a field configuration described in the following is just an embodiment only. The field configuration can be differently configured according to a registered NAN proxy server client.

TABLE 15
Proxy Server Attribute (≈Proxy server capability attribute)

Attribute ID
Device ID (Proxy server ID)
Instance ID
MAC interface
Publish mode
Subscribe mode
TBTT of Proxy server
Registered Proxy Client ID
Registered Proxy Client MAC interface
Service info of Registered Proxy Client
TBTT of Proxy client
Awake interval of Proxy client

[symbol]

According to a more specific embodiment, when a NAN proxy client A, a NAN proxy client B, and a NAN proxy client C are registered at the NAN proxy server, as shown in Table 16 in the following, information on each of the NAN proxy clients can be included in the proxy server attribute, by which the present invention may be non-limited.

TABLE 16
Proxy Server Attribute (≈Proxy server capability attribute)

Attribute ID
Device ID (Proxy server ID)
Instance ID
MAC interface
Publish mode
Subscribe mode
Registered Proxy Client ID (A)
Registered Proxy Client A MAC interface
Service info of Registered Proxy Client A
TBTT of Proxy client A
Awake interval of Proxy client A
Registered Proxy Client ID (B)
Registered Proxy Client B MAC interface
Service info of Registered Proxy Client B
TBTT of Proxy client B
Awake interval of Proxy client B
Registered Proxy Client ID (C)
Registered Proxy Client C MAC interface
Service info of Registered Proxy Client C
TBTT of Proxy client C
Awake interval of Proxy client C

[symbol]

For example, Table 17 in the following shows a format of a proxy client attribute. More specifically, the proxy client attribute can be included in a service discovery frame transmitted to the NAN proxy server by a NAN proxy client. In this case, for example, proxy client address corresponding to a NAN interface address of the NAN proxy client can be included in the proxy client attribute. And, proxy server address corresponding to a NAN interface address of the NAN proxy server can be included in the proxy client attribute. And, awake interval corresponding to an awake interval of a discovery window can be included in the proxy client attribute. In this case, the awake interval can indicate an awake interval of the NAN client in a unit of a discovery interval after the NAN proxy client requests publish, subscribe, and follow-up to the NAN proxy server.

For example, the NAN proxy client requests publish to the NAN proxy server and the awake interval of the proxy client attribute can be set to 3. In this case, the NAN proxy client can awake in every 3 discovery windows after being registered at the NAN proxy server. In particular, the NAN proxy client can awake in a first discovery window, a fourth discovery window, and a seventh discovery window. And, the NAN proxy client can awake with the same interval. Subsequently, if it is necessary for NAN proxy client to connect with the NAN proxy server, as mentioned in the foregoing description, the NAN proxy client can transmit a subscribe message to the NAN proxy server. And, the NAN proxy client can transmit a follow-up to the NAN proxy server to form a role with the NAN proxy server. And, the NAN proxy client can transmit publish to the NAN proxy server to inform the NAN proxy server of a service performed by the NAN proxy client.

In this case, an awake interval of a discovery window can be determined according to characteristic or definition of the NAN proxy client. In this case, for example, it may be able to define a proxy server address and DW awake interval in addition to a legacy publish. By doing so, the NAN proxy client may leave a publish role of the NAN proxy client to the NAN proxy server. In particular, the NAN proxy client awakes in a discovery window of a specific interval only and matches synchronization with the NAN proxy server, thereby reducing power consumption.

In this case, for example, the NAN proxy server may always awake with a multiple of an awake interval of the NAN proxy client. In particular, the NAN proxy client can awake in a discovery window of a prescribed interval only based on an awake interval. And, the NAN proxy server may always awake in the discovery window in which the NAN proxy client awakes to exchange data with the NAN proxy client. By doing so, the NAN proxy client can perform data communication with other terminals while reducing power consumption using the NAN proxy server.

TABLE 17

| | Size | | |
|---|---|---|---|
| Field | (Octets) | Value | Description |
| Attribute ID | 1 | 0x15 | Identifies the type of NAN |
| | | | attribute (TBD) |
| Length | 2 | Variable | Length of the following |
| | | | fields in the attribute. |
| Proxy client | 6 | Variable | NAN Interface address of |
| Address | | | NAN Device |
| Proxy Server | 6 | Variable | NAN Interface address of |
| Address | | | NAN Proxy Server |
| Awake Interval | 1 | Variable | Wake up interval of this |
| | | | Proxy Client (unit of DW |
| | | | interval) |
| BSSID | 6 | Variable | BSSID which is support by |
| | | | Proxy Service |

[symbol]

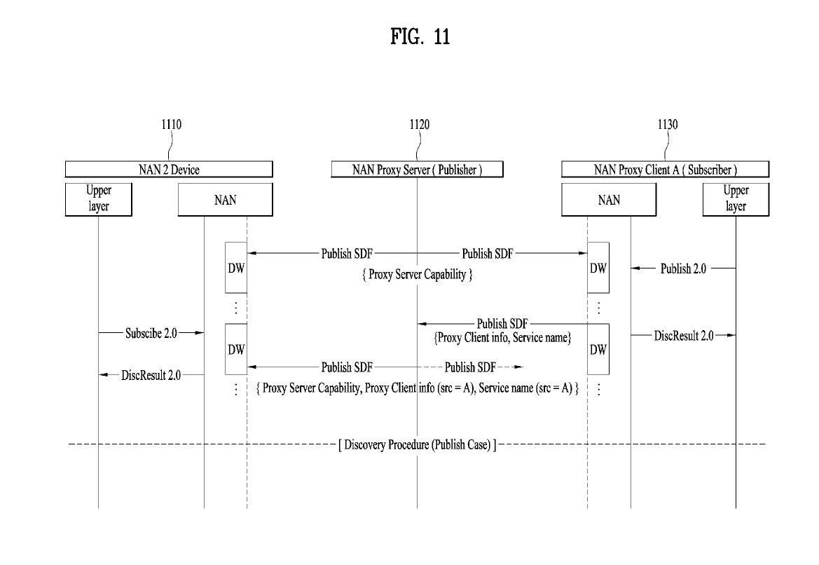

FIG. 11 is a diagram illustrating a method of discovering a NAN proxy service through a NAN proxy server.

A NAN proxy client can be registered at a NAN proxy server. In this case, the NAN proxy server can perform a publish/subscribe function on behalf of the NAN proxy client. In particular, the NAN proxy server can perform a procedure for performing communication on behalf of the NAN proxy client.

More specifically, the NAN proxy client registered at the NAN proxy server awakes a predetermined discovery window period only and may be able to match synchronization with the NAN proxy server. In particular, the NAN proxy server and the NAN proxy client can match synchronization in the discovery window in which the NAN proxy client is awaked. In this case, for example, the NAN proxy server can awake in all discovery windows. In this case, if there is a NAN terminal intending to perform communication with the NAN proxy client, the NAN proxy server keeps information on the NAN terminal and information on the communication and can forward the information to the NAN proxy client in the discovery window in which the NAN proxy client is awaked. If the NAN proxy client performs communication with a different NAN terminal, the NAN proxy client can switch to a general mode from a PS (power saving) mode. In particular, the NAN proxy client can awake in all discovery windows and can perform communication with a different NAN terminal via the discovery windows. For example, if the NAN proxy client switches to the general mode, the registration of the NAN proxy client registered at the NAN proxy server can be cancelled.

If the NAN proxy client finishes communication with a different NAN terminal, the NAN proxy client transmits a subscribe message to the NAN proxy server to register at the NAN proxy server again. If the NAN proxy client registers at the NAN proxy server again, the NAN proxy client can awake according to a prescribed window interval. By doing so, the NAN proxy client can reduce power consumption.

In the following, a method for a different NAN terminal to perform discovery in a state that the NAN proxy client is registered at the NAN proxy server is explained.

In this case, for example, referring to FIG. 11, the NAN proxy client 1130 may be in a state of being registered at the NAN proxy server 1120 via the aforementioned procedure. In this case, the NAN proxy server can periodically publish a service discovery frame including capability of the proxy server. And, for example, if an event is triggered, the NAN proxy server 1120 can periodically publish a service discovery frame including capability of the proxy server.

In this case, the NAN proxy client 1130 provides all information of the NAN proxy client to the NAN proxy server 1120 and switches to a sleep mode to reduce power consumption. In this case, the NAN proxy client 1130 can publish proxy client information of the NAN proxy client and information on a preferred service name through the service discovery frame.

In this case, the NAN proxy server 1120 can receive the service discovery frame from the NAN proxy client 1130. Subsequently, the NAN proxy server 1120 can add the proxy client information and the service name included in the service discovery frame received from the NAN proxy client 1130 in the process of publishing a next service discovery frame. In particular, the service discovery frame published by the NAN proxy server 1120 can include information on the NAN proxy client 1130.

In this case, a different NAN terminal 1110 can subscribe to the service discovery frame published by the NAN proxy server 1120. By doing so, the NAN terminal 1110 is able to know the information on the NAN proxy client 1130. In this case, for example, if a plurality of NAN proxy clients 1130 are registered at the NAN proxy server 1120, the service discovery frame can include information on all registered NAN proxy clients. In particular, the NAN terminal 1110 can receive information on the NAN proxy clients 1130 and information on whether or not a service is used.

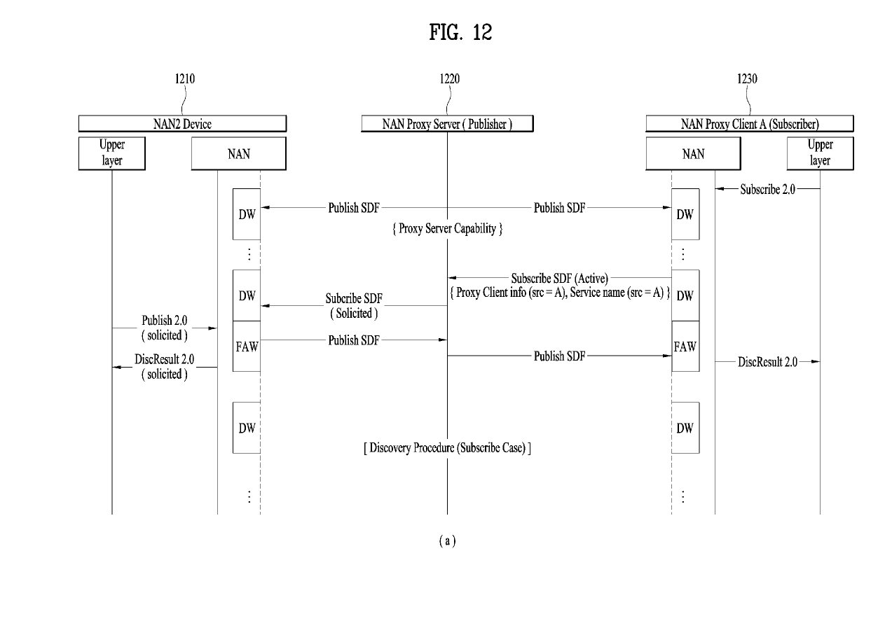

FIG. 12 is a diagram illustrating a method of performing discovery.

As mentioned in the foregoing description, a NAN terminal 121 can perform service discovery via a NAN proxy server 1220.

A NAN proxy client 1230 can actively subscribe to information of the NAN proxy client. In particular, the NAN proxy client 1230 can subscribe to a service discovery frame including proxy client information and a service name. In particular, the NAN proxy client 1230 can transmit a message of a request form to the NAN proxy server 1220 to perform communication with a different NAN terminal.

In this case, for example, the NAN proxy server 1220 may perform an operation in a manner of dividing the operation into solicited publish and unsolicited publish. In this case, for example, if a NAN terminal receives the solicited publish, the NAN terminal should reply to the solicited publish. If a NAN terminal receives the unsolicited publish, the NAN terminal may not reply to the unsolicited publish.

For example, referring to FIG. 12 (a), the NAN proxy server 1220 can transmit the solicited publish to the NAN terminal 1210. Having received the solicited publish, the NAN terminal 1210 can transmit a publish including a service discovery frame to the NAN proxy server 1220 in response to the solicited publish. In this case, the service discovery frame published by the NAN terminal 1210 can include information on whether or not the NAN terminal 1210 supports a service of the NAN proxy client 1230. If the NAN proxy server 1220 receives the service discovery frame published by the NAN terminal 1210, the NAN proxy server 1220 can transmit a service discovery frame including the information received from the NAN terminal 1210 to the NAN proxy client 1230 via a publish.

In this case, for example, the NAN proxy server 1220 can keep the information received from the NAN terminal 1210. Subsequently, the NAN proxy server 1220 can provide the information of the NAN terminal 1210 to the NAN proxy client 1230 by publishing a service discovery frame in a discovery window in which the NAN proxy client 1230 is awaked.

And, for example, the NAN terminal 1210, the NAN proxy server 1220, and the NAN proxy client 1230 can perform a publish including a service discovery frame in a further available window (FAW), by which the present invention may be non-limited.

And, for example, referring to FIG. 12 (b), if the NAN proxy server 1220 transmits unsolicited publish to the NAN terminal 1210, the NAN terminal may not perform a separate response. In particular, the NAN terminal 1210 may not perform an additional procedure after information on a service supported by the NAN proxy client 1230 is obtained.

In this case, for example, if necessary, the NAN terminal 1210 may directly transmit information to the NAN proxy client 1230 or may transmit information to the NAN proxy server 1220, by which the present invention may be non-limited.

[symbol]

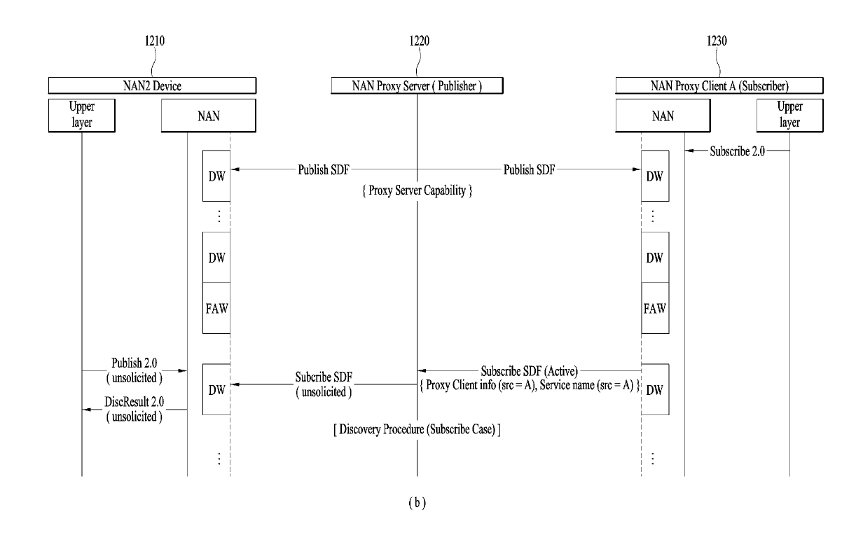

FIG. 13 is a diagram illustrating a service discovery method performed in various types.

A NAN proxy server can search for a different NAN terminal capable of performing communication on behalf of a NAN proxy client.

In this case, referring to FIG. 13, the NAN proxy client 1330 registered at the NAN proxy server 1320 may be in a sleep state. In particular, the NAN proxy server 1320 can provide information of the NAN proxy client 1330 to the NAN terminal 1310 by publishing the information by unsolicited on behalf of the NAN proxy client 1330.

In this case, for example, a service/application layer of the NAN terminal 1310 can provide a subscribe method to a NAN DE (discovery engine) and a NAN MAC layer of the NAN terminal 1310. And, the service/application layer of the NAN terminal 1310 can provide a publish method to the NAN DE (discovery engine) and the NAN MAC layer of the NAN terminal 1310. Although following description is described on the basis of the subscribe method, the description can be identically applied to the publish method as well.

In this case, the subscribe method provided to the NAN DE and the NAN MAC of the NAN terminal 1310 by the service/application layer of the NAN terminal 1310 can be represented as Table 18 in the following.

In this case, the subscribe method can include at least one information selected from the group consisting of information on a service name, information on service_specific_info and configuration_parameter, information on a discovery range, information on a query period, and information on awake time (time to live).

In this case, for example, information on a subscribe type can be included in the subscribe method. In this case, the subscribe method type may correspond to either a passive type or an active type.

If the subscribe method type corresponds to the passive type, the NAN terminal 1310 passively subscribes to the NAN DE and the NAN MAC internally. In particular, the NAN terminal 1310 receives a publish message transmitted by the NAN proxy server 1320 and obtains information of the NAN proxy client 1330 only. The NAN terminal 1310 may not directly transmit a subscribe message.

And, for example, if the subscribe method type corresponds to the active type, the NAN terminal 1310 can actively transmit a subscribe message to the NAN proxy server 1320. In particular, the NAN terminal 1310 can directly subscribe to a service of the NAN proxy server 1320.

In this case, for example, the step S1340 shows a case that the subscribe method type corresponds to a passive type. In this case, the service/application layer of the NAN terminal 1310 can provide a subscribe method of a passive type to the NAN DE and the NAN MAC layers of the NAN terminal 1310. In this case, the NAN terminal 1310 can receive a publish message transmitted by the NAN proxy server 1320. Having received the publish message, the NAN terminal 1310 can complete discovery.

In this case, the NAN DE and the NAN MAC layers of the NAN terminal 1310 can provide a discovery result event to the NAN service/application layer. For example, the discovery result event can include information on whether or not there is a NAN proxy client capable of performing communication with the NAN terminal 1310 based on a service. And, the discovery result event can include information on the NAN proxy client 1330 capable of performing communication with the NAN terminal 1310. In this case, the information on the NAN proxy client 1330 may correspond to proxy client information, a service name, and the like, by which the present invention may be non-limited. And, for example, if the publish message type transmitted by the NAN proxy server 1320 corresponds to an unsolicited type, as mentioned in the foregoing description, the NAN terminal 1310 may not provide a separate response to the NAN proxy server 1320.

```
TABLE 18
Subscribe( service_name, service_specific_info,
configuration_parameters )
- service_name:
  UTF-8 name string which identifies the service/application
- service_specific_info:
  Sequence of values which further specify the published service beyond
the service name
- configuration_parameters
  > Subscribe type:
  Determines the type of Subscribe as follows
    ∘ Passive:
    NAN device can passively subscribe to internal NAN DE.
    ∘ Active:
    NAN device can actively subscribe to proxy
    server.
- Discovery range:
  Determines whether the service is searched in close proximity only or
in any NAN Devices within range
- Query period:
  Recommended periodicity of query transmissions
- Time to live:
  The instance of the Subscribe function can be commanded to run for a
given time interval or until the first DiscoveryResult event
```

[symbol]

The step S1350 corresponds to a case that a subscribe method type is configured by an active type. In particular, the step S1350 may correspond to a case that the NAN proxy server 1320 transmits a solicited publish message to the NAN terminal 1310.

In this case, for example, the NAN terminal 1310 can actively subscribe to the NAN proxy server 1320 for a proxy service preferred by the NAN terminal. In particular, the NAN terminal 1310 can transmit a subscribe message to the NAN proxy server 1320. In this case, the NAN proxy server 1320 can provide proxy service information of the NAN proxy server to the NAN terminal 1310 via solicited publish. In particular, the NAN proxy server 1320 can provide information on the NAN proxy client 1330 registered at the NAN proxy server to the NAN terminal 1310.

In this case, for example, if the NAN proxy server 1320 receives the subscribe message from the NAN terminal 1310, the NAN proxy server 1320 can match a proxy service of the NAN proxy server with a service to which the NAN terminal 1310 subscribes. More specifically, the subscribe message can include information on a service to be used by the NAN terminal 1310. In this case, the NAN proxy server 1320 can check whether or not there exists a service by matching the information on the service included in the subscribe message with the information of the NAN proxy server.

Subsequently, the NAN proxy server 1320 can transmit a publish message to the NAN terminal 1310. In this case, for example, the publish message transmitted by the NAN proxy server 1320 may have a form identical to a form of a legacy publish message. In particular, the NAN proxy server 1320 can transmit the publish message including information capable of being used by the NAN proxy client 1330 and an interface address to the NAN terminal 1310, by which the present invention may be non-limited.

Subsequently, as mentioned in the foregoing description, the NAN DE and the NAN MAC layers of the NAN terminal 1310 can provide the discovery result event to the service/application layer of the NAN terminal 1310.

In this case, for example, primitives of the discovery result event can be represented as Table 19 in the following.

```
TABLE 19
DiscoveryResult( subscribe_id, service_specific_info,
publish_id, address )
- subscribe_id:
  As originally returned by the instance of the Subscribe function
- service_specific_info:
  Sequence of values which were decoded from a frame received from the
Proxy server
- publish_id:
  Identifier for the instance of the published service on a remote Proxy
server
- Address:
  NAN Interface Address of the Proxy Server
```

[symbol]

As a different example, the step S1360 may correspond to a case that the NAN proxy server 1320 performs active subscribe and the NAN terminal 1310 performs solicited publish. In this case, for example, the NAN proxy server 1320 can perform the active subscribe to subscribe to a proxy service included in the NAN proxy server on behalf of the NAN proxy client 1330. In particular, the NAN proxy server 1320 can transmit a subscribe message including information on a proxy service to the NAN terminal 1310. And, for example, if the NAN proxy server 1320 receives active subscribe from the NAN proxy client 1330, the NAN proxy server 1320 can perform the active subscribe. In particular, the NAN proxy server 1320 can transmit the subscribe message to the NAN terminal 1310 after a message for performing subscribe is received from the NAN proxy client 1330. Having received the subscribe message, the NAN terminal 1310 can provide publish to the NAN proxy server 1320. In this case, a type of the publish may correspond to a solicited type.

For example, if the NAN terminal 1310 provides the publish to the NAN proxy server 1320, the service/application layer of the NAN terminal 1310 can provide a solicited publish method to the NAN DE and the NAN MAC layers of the NAN terminal 1310. In this case, primitives of the solicited publish method can be represented as Table 20 in the following. In particular, the solicited publish method can include at least one selected from the group consisting of a service name, service specific information, and configuration information (configuration parameter).

In this case, the NAN terminal 1310 can transmit a publish message to the NAN proxy server 1320 based on the solicited publish method. In this case, for example, the publish message may be identical to a legacy publish message. Having received the publish message, the NAN proxy server 1320 can check whether or not a proxy service of the NAN proxy server is matched with a service published by the NAN terminal 1310. By doing so, it is able to perform discovery.

```
TABLE 20
Publish( service_name, service_specific_info,
configuration_parameters )
- service_name:
  UTF-8 name string which identifies the service/application
- service_specific_info:
  Sequence of values which should be conveyed to the Discovery Engine
of a NAN Device that has invoked a Subscribe method corresponding to
this Publish method.
- configuration_parameters
  > Publish type:
    Solicited transmissions only
  > Solicited transmission type:
    Determines whether a solicited transmission is a unicast or a
broadcast transmission
  > Time to live:
    The instance of the Publish function can be commanded to run for a
given time interval or fur one transmission only
  > Event conditions:
    Determines when Publish related events are generated. Events can be
requested to be generated on each solicited transmission. Alternatively, no
events are expected.
```

[symbol]

And, the NAN proxy server 1320 can receive a discovery result request in a discovery window (or further available window) in which the NAN proxy client 1330 is awaked. The NAN proxy server 1320 can transmit a discovery result response to the NAN proxy client 1330 in response to the discovery result request. In this case, the discovery result response can also be transmitted in a discovery window (or further available window) in which the NAN proxy client 1330 is awaked.

In this case, if the NAN proxy server 1320 completes a discovery on the NAN terminal 1310 by performing one of the steps S1340, S1350, and S1360, the NAN proxy server 1320 can provide a discovery result response including information on the NAN terminal 1310 to the NAN proxy client 1330. In the contrary, if the discovery is not performed, the NAN proxy server 1320 can provide information on a result failure to the NAN proxy client 1440.

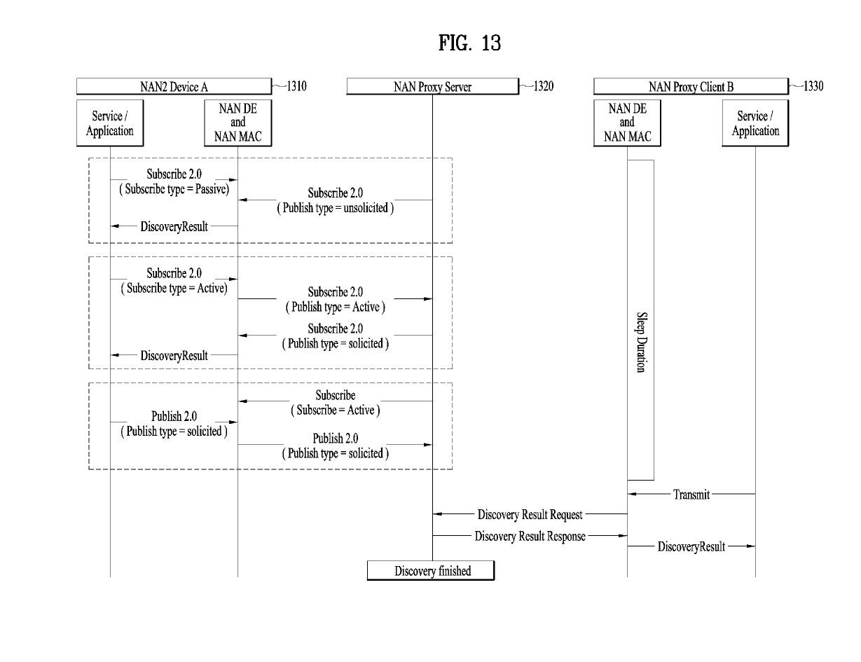

FIG. 14 is a diagram illustrating a method of establishing a session with a NAN proxy client after a NAN terminal is registered at a NAN proxy server.

As mentioned in the foregoing description, the NAN proxy server can discover the NAN terminal performing communication on behalf of the NAN proxy client. In this case, in order for the NAN terminal to perform communication with the NAN proxy client registered at the NAN proxy server, it is necessary for the NAN terminal to register at the NAN proxy server. More specifically, referring to FIG. 14, the NAN terminal 1410 can complete a discovery procedure via the NAN proxy server 1420. Subsequently, the NAN terminal 1410 can transmit a proxy register request to the NAN proxy server. In this case, for example, the service/application layer of the NAN terminal 1410 can provide a proxy register method to the NAN DE and the NAN MAC layers of the NAN terminal 1410. The NAN terminal 1410 can transmit the proxy register request to the NAN proxy server based on the proxy register method. In this case, the register request can be transmitted via a service discovery frame.

In this case, for example, the service discovery frame in which the register request is transmitted can include information on Table 21 in the following. In particular, the service discovery frame in which the register request is transmitted can include information necessary for registration. In particular, information on an awake interval of the NAN proxy client after the NAN proxy client is registered at the NAN proxy server can be included in the service discovery frame.

TABLE 21
Proxy Service Register Request SDF

Device ID
Service ID
Instance ID
MAC Interface
Power save mode
TBTT
Awake interval
Service info

[symbol]

Subsequently, the NAN terminal 1410 can receive a proxy register response from the NAN proxy server 1420.

In this case, for example, the proxy register response may correspond to a service discovery frame. And, for example, the service discovery frame in which the register response is transmitted can be configured as Table 22 in the following. In particular, information on registration completion can be included in the service discovery frame in which the register response is transmitted.

TABLE 22
Proxy Service Register Response SDF

Device ID
Confirm status

[symbol]

In this case, the NAN DE and the NAN MAC layers of the NAN terminal 1410 can provide a proxy status event to the service/application layer of the NAN terminal 1410. By doing so, the NAN terminal 1410 can register at the NAN proxy server 1420. And, a procedure for the NAN terminal 1410 to register at the NAN proxy server 1420 can be performed in a manner of being identical to the method disclosed in FIG. 10, by which the present invention may be non-limited.

And, for example, the proxy register request and the proxy register response can be exchanged in a discovery window (or further available window), by which the present invention may be non-limited.

And, for example, the NAN proxy client 1430 can consistently maintain a sleep mode while the NAN terminal 1410 performs the procedure for registering at the NAN proxy server 1410.

Subsequently, the NAN terminal 1410 (hereinafter, a NAN proxy client B) newly registered at the NAN proxy server 1420 can establish a session with a legacy NAN proxy client 1430 (hereinafter, a NAN proxy client A).

In this case, the NAN proxy client B 1410 can transmit a connect session request to the NAN proxy server 1420 to establish the session with the NAN proxy client A 1430. In this case, the connect session request can be transmitted via a service discovery frame. And, for example, the NAN proxy client B 1410 can be awaked in a prescribed discovery window interval. The NAN proxy client B 1410 can transmit the connect session request to the NAN proxy server 1420 in the discovery window in which the NAN proxy client B 1410 is awaked. Subsequently, the NAN proxy client B 1410 can receive a connect session response from the NAN proxy server 1420. In this case, the connect session response may correspond to a service discovery frame. And, the NAN proxy client B 1410 can receive the connect session response from the NAN proxy server 1420 in a discovery window in which the NAN proxy client B 1410 is awaked, by which the present invention may be non-limited.

And, for example, the connect session request and the connect session response can include information necessary for performing data transmission between the NAN proxy client A 1430 and the NAN proxy client B 1410, by which the present invention may be non-limited.

And, for example, having received the connect session response, the NAN proxy client B 1410 can awake in every discovery window. In particular, the NAN proxy client B 1410 may switch to a mode of awaking in every discovery window to establish a session with the NAN proxy client A 1430, by which the present invention may be non-limited.

Subsequently, the NAN proxy server 1420 can transmit a connect session request to the NAN proxy client A 1430. In this case, for example, the NAN proxy client A 1430 can also awake based on a prescribed discovery window period. Hence, the NAN proxy server 1420 can transmit the connect session request in a discovery window (or further available window) in which the NAN proxy client A 1430 is awaked. In this case, the connect session request may correspond to a service discovery frame.

And, the NAN proxy client A 1430 can transmit a connect session response to the NAN proxy server 1420 in response to the connect session request. In this case, the NAN proxy client A 1430 can transmit the connect session response in a discovery window (or further available window) in which the NAN proxy client A 1430 is awaked. In this case, for example, the connect session response may correspond to a service discovery frame. NAN DE and NAN MAC layers of the NAN proxy client A 1430 can provide a session status event to a service/application layer of the NAN proxy client A 1430. Subsequently, the NAN proxy client A 1430 can switch to a normal mode from a sleep mode. In particular, the NAN proxy client A 1430 can switch to a mode of awakening in every discovery window.

And, the NAN proxy server 1420 can transmit the connect session response, which is received from the NAN proxy client A 1430, to the NAN proxy client B 1410. In this case, since the NAN proxy client B 1410 is switched to a status of being awaked in every discovery window, the NAN proxy server 1420 can immediately provide the connect session response to the NAN proxy client B 1410.

The NAN proxy client A 1430 and the NAN proxy client B 1410 can obtain session connect information for performing data communication. Subsequently, the NAN proxy client A 1430 and the NAN proxy client B 1410 can directly establish an application socket connection. In this case, the NAN proxy client A 1430 and the NAN proxy client B 1410 can establish the application socket connection in a discovery window or a further available window. Subsequently, the NAN proxy client A 1430 and the NAN proxy client B 1410 can practically exchange a service specific application data rather than the discovery window period.

In particular, the NAN terminal 1410 can perform data communication with the NAN proxy client 1430 after being registered at the NAN proxy server 1420, by which the present invention may be non-limited.

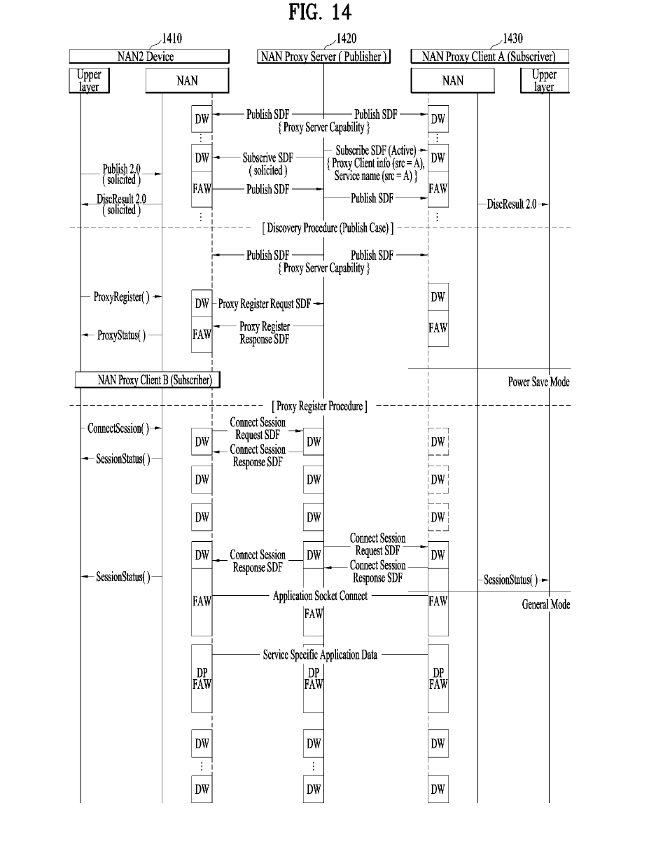

FIG. 15 is a diagram illustrating a method for a NAN terminal to establish a session with a NAN proxy client.

FIG. 15 shows a method for an NAN terminal 1510 to establish a session with a legacy NAN proxy client 1530 without registering at a NAN proxy server 1520 after a discovery procedure is performed.

In this case, for example, the NAN terminal 1510 may attempt to establish a session with the legacy NAN proxy client 1530 after a discovery procedure is completed. In this case, the service/application layer of the NAN terminal 1510 can provide a connection session method to the NAN DE and the NAN MAC layers of the NAN terminal 1510. Subsequently, the NAN DE and the NAN MAC layers of the NAN terminal 1510 can provide a session status event to the service/application layer of the NAN terminal 1510. In this case, the NAN terminal 1510 may be in a state capable of establishing a session with the NAN proxy client 1530. In this case, the NAN terminal 1510 can perform a direction connection with the NAN proxy client 1530. In this case, the NAN proxy client 1530 may not awake in every discovery window. Hence, the NAN terminal 1510 waits for a discovery window (or further available window) in which the NAN proxy client 1530 is awaked based on information received from the NAN proxy server 1520 and may be able to directly establish a session with the NAN proxy client. In particular, the NAN terminal 1510 can transmit a connect session request in the discovery window in which the NAN proxy client 1530 is awaked. Subsequently, the NAN terminal 1510 can receive a connect session response from the NAN proxy client 1530. Subsequently, the NAN terminal 1510 and the NAN proxy client 1530 can establish an application socket connection in a discovery window or a further available window. Subsequently, as mentioned in the foregoing description, the NAN terminal 1510 and the NAN proxy client 1530 can practically exchange a service specific application data rather than a discovery window period.

In this case, for example, having received the connect session request, as mentioned in the foregoing description, the NAN proxy client 1530 can awake in every discovery window.

And, for example, the proxy register request, the proxy register response, the connect session request, and the connect session response correspond to service discovery frames and can be defined as a general action frame, by which the present invention may be non-limited.

And, the NAN proxy server 1520 can be configured to awake in every discovery window. By doing so, the NAN proxy server 1520 can perform a function of the registered NAN proxy client 1530 on behalf of the NAN proxy client.

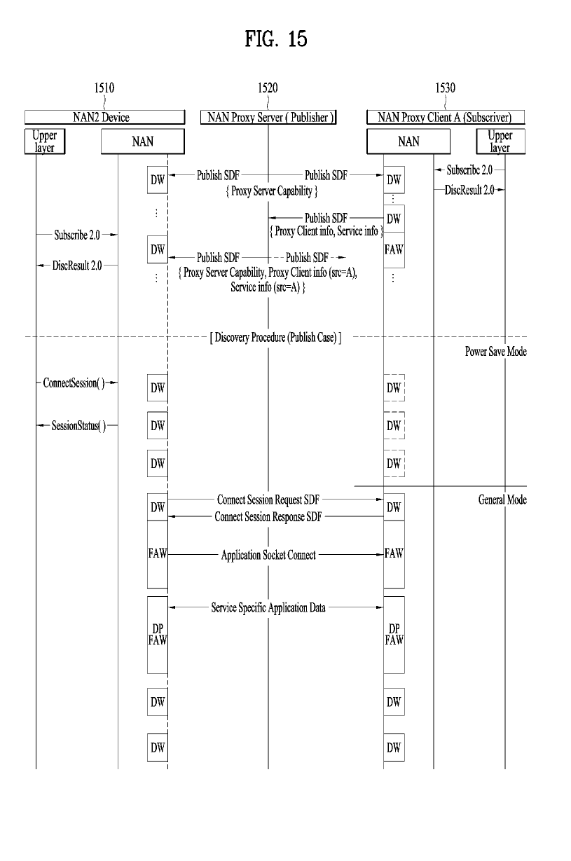

FIG. 16 is a diagram illustrating a method for a NAN proxy server and a NAN proxy client to cancel registration.

A NAN proxy server 1610 can cancel a connection connected with a NAN proxy client 1620. In this case, for example, the connection connected with the NAN proxy server 1610 can be cancelled by a request of the NAN proxy client 1620. In this case, a service/application layer (or upper layer) of the NAN proxy client 1620 can provide a proxy release method to NAN DE and NAN MAC layers of the NAN proxy client 1620. Subsequently, the NAN proxy client 1620 can transmit a proxy release request to the NAN proxy server 1610. In this case, the proxy release request may correspond to a service discovery frame. Subsequently, the NAN DE and the NAN MAC layers of the NAN proxy server 1610 can provide a proxy release request event to the service/application layer of the NAN proxy server 1610. Subsequently, the service/application layer of the NAN proxy server 1610 can provide a proxy release confirm method to the NAN DE and the NAN MAC layers of the NAN proxy server 1610. In this case, the NAN proxy server 1610 can transmit a proxy release response to the NAN proxy client 1620. In this case, for example, the proxy release request and the proxy release response can be exchanged in a discovery window or a further available window.

Subsequently, if the NAN proxy client 1620 receives the proxy release request, the NAN DE and the NAN MAC layers of the NAN proxy client 1620 can provide a proxy status event to the service/application layer of the NAN proxy client 1620. By doing so, the NAN proxy client 1620 can cancel the registration of the NAN proxy server 1610.

And, for example, the registration of the NAN proxy client 1620 can also be cancelled by the NAN proxy server 1610, by which the present invention may be non-limited.

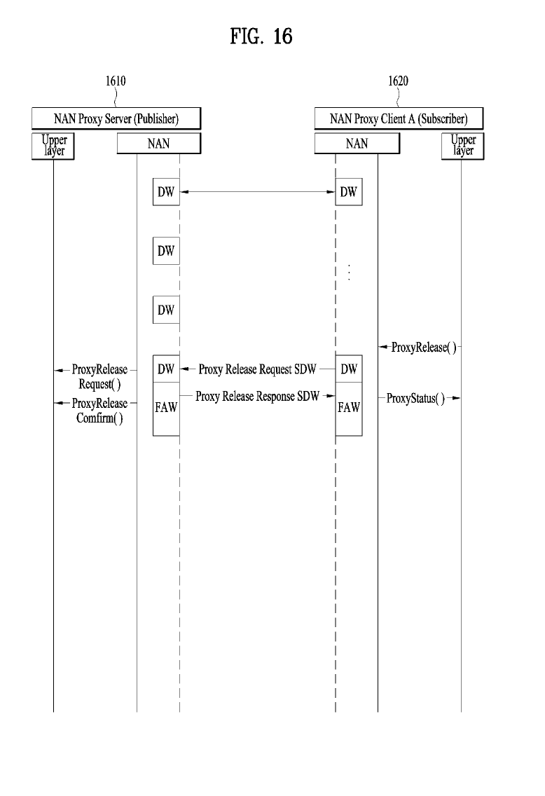

FIGS. 17 to 20 are diagrams illustrating a method of performing discovery according to each type.

As mentioned in the foregoing description, a NAN proxy server can perform a procedure for performing communication on behalf of a NAN proxy client after the NAN proxy client registers at the NAN proxy server. In this case, for example, it may perform discovery on an operation performed between the NAN proxy server and a different NAN terminal based on publish/subscribe. And, it may also perform discovery on the operation performed between the NAN proxy server and the different NAN terminal based on passive/active. In this case, a method of performing the discovery in consideration of each status is explained in the following.

FIG. 17 is a diagram illustrating a method of performing discovery based on unsolicited publish type. As mentioned in the foregoing description, a NAN proxy client 1730 can be registered at a NAN proxy server 1720. In this case, the NAN proxy server 1720 can periodically publish a service discovery frame. In this case, a publish type may correspond to an unsolicited type. In particular, a different NAN terminal 1710 may not send a separate response after a published service discovery frame is received. And, information on the registered NAN proxy client 1730 can be included in the service discovery frame. Subsequently, having received the service discovery frame, the NAN terminal 1710 can check whether or not a service of the NAN proxy client 1730 included in the service discovery frame corresponds to a service preferred by the NAN terminal 1710. In this case, for example, the NAN terminal 1710 can directly perform service matching based on information on the service included in the service discovery frame. By doing so, the NAN terminal 1710 can check whether or not a service corresponds to a service preferred by the NAN terminal 1710. Subsequently, when the NAN terminal 1710 performs communication with the NAN proxy client 1730, the NAN terminal 1710 can establish a session with the NAN proxy client to perform direct communication with the NAN proxy client 1730. In this case, for example, the NAN terminal 1710 can obtain information on a discovery window period during which the NAN proxy client 1730 is awaked via a service discovery frame. In this case, the NAN terminal 1710 awakes in the discovery window in which the NAN proxy client 1730 is awaked and can establish a direct session with the NAN proxy client 1730. In particular, according to the unsolicited publish type, the NAN terminal 1710 can establish a session with the NAN proxy client 1730 via direct service matching without a separate response after a service discovery frame is received from the NAN proxy server 1720.

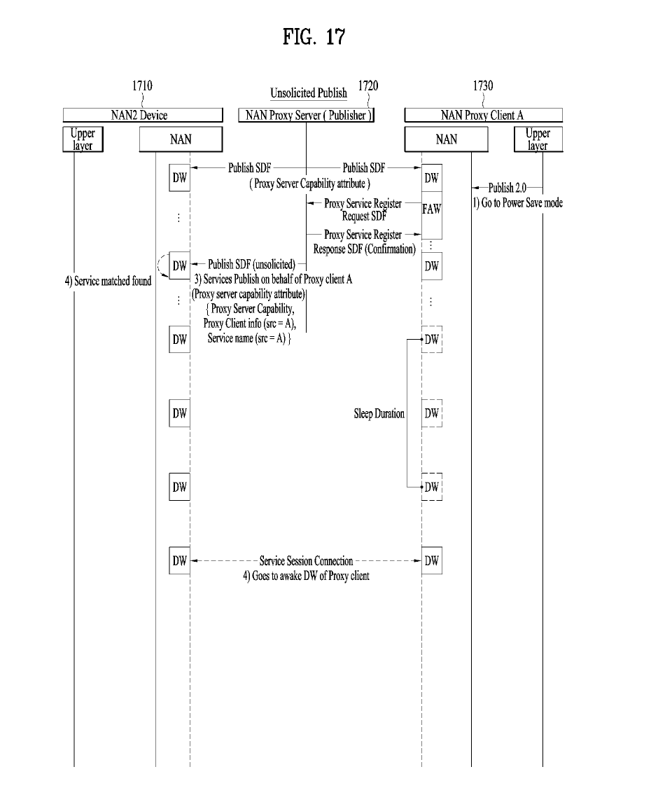

FIG. 18 is a diagram illustrating a method of performing discovery based on solicited publish type. When a NAN terminal 1810 intends to search for a NAN proxy client 1830 having a service preferred by the NAN terminal, the NAN terminal 1810 can actively subscribe to a NAN proxy server 1820. In this case, a subscribe type may correspond to a solicited type. In particular, the NAN terminal 1810 can transmit a subscribe message to the NAN proxy server 1820. In this case, for example, the subscribe message can include device service attribute information corresponding to information on the service preferred by the NAN terminal 1810. In this case, for example, the device service attribute information can be represented as Table 23 in the following.

TABLE 23
Device Service Attribute

Attribute ID
Device ID
Instance ID
MAC interface
Publish mode
Subscribe mode
Service info

[symbol]

Subsequently, the NAN proxy server 1820 can determine whether or not information of the registered NAN proxy client 1830 is identical to the service included in the subscribe message. In this case, if the information of the registered NAN proxy client 1830 is identical to the service included in the subscribe message, the NAN proxy server 1820 can publish a service discovery frame again. In this case, for example, service descriptor attribute information and NAN connection capability attribute information can be additionally included in the service discovery frame. In particular, additional information can be included in the service discovery frame to make the NAN terminal 1810 establish a session with the registered NAN proxy client 1830. Subsequently, the NAN terminal 1810 awakes in a discovery window in which the NAN proxy client 1830 is awaked to establish a direct session with the NAN proxy client 1830. In particular, according to the solicited publish type, the NAN terminal 1810 transmits a subscribe message of a solicited type to the NAN proxy server 1820, receives a response from the NAN proxy server 1820, and establish a session with the NAN proxy client 1830.

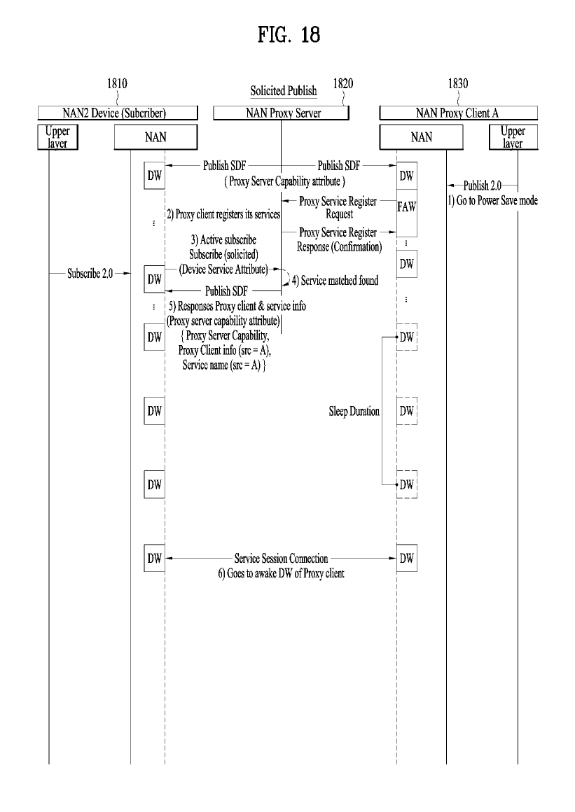

FIG. 19 is a diagram illustrating a method of performing discovery based on a passive subscribe type on the basis of a NAN proxy server. When a NAN terminal 1910 intends to search for a NAN proxy client 1930 having a service preferred by the NAN terminal, the NAN terminal 1910 can actively subscribe to a NAN proxy server 1920. In this case, a subscribe type may correspond to an unsolicited type. In particular, the NAN terminal 1910 can transmit a subscribe message to the NAN proxy server 1920. In this case, for example, the subscribe message can include device service attribute information corresponding to information on the service preferred by the NAN terminal 1910. In this case, for example, the device service attribute information can be represented as Table 23 mentioned above. In this case, since the subscribe type corresponds to the unsolicited type, the NAN proxy server 1920 may not publish a separate service discovery frame to the NAN terminal 1910. In this case, for example, the NAN proxy server 1920 can wait for a discovery window in which the NAN proxy client 1930 is awaked. Subsequently, the NAN proxy server 1920 can transmit a service discovery frame to the NAN proxy client 1930 in the discovery window in which the NAN proxy client 1930 is awaked by publishing the service discovery frame. In this case, the publish type may correspond to an unsolicited type. In this case, device service attribute information received from the NAN terminal 1910 can be included in the service discovery frame. In this case, for example, if the NAN proxy client 1930 receives a publish message, the NAN proxy client 1930 can awake in every discovery window. Subsequently, the NAN proxy client 1930 can establish a session with the NAN terminal 1910.

In particular, according to the passive subscribe type, the NAN proxy server 1920 receives information on a service from the NAN terminal 1910, delivers the information to the NAN proxy client 1930, and establishes a session with the NAN terminal 1910 and the NAN proxy client 1930.

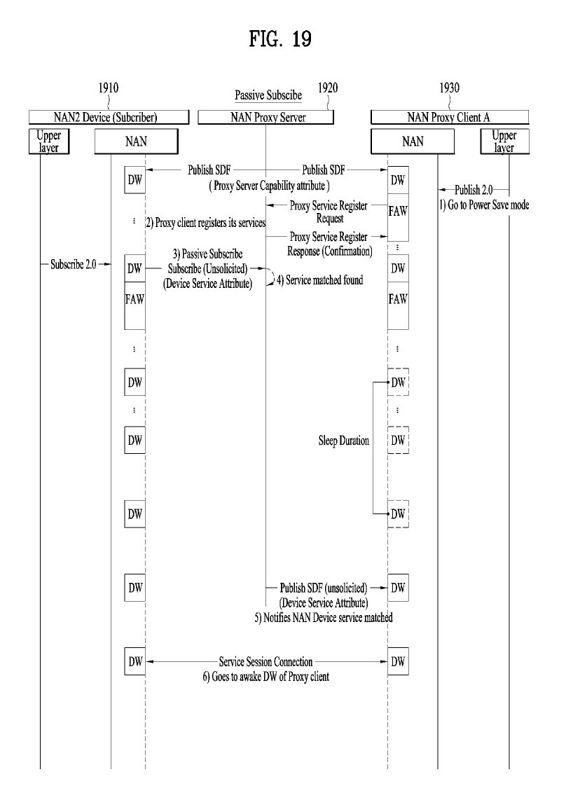

FIG. 20 is a diagram illustrating a method of performing discovery based on an active subscribe type on the basis of a NAN proxy server.

A NAN proxy server 2020 can publish a service discovery frame to a NAN terminal 2010 on behalf of a NAN proxy client 2010. In this case, information on the NAN proxy client 2030 can be included in a publish message. Subsequently, the NAN proxy server 2020 can receive a subscribe message including device service attribute information from the NAN terminal. In this case, the device service attribute information can be represented as Table 23 mentioned above. Subsequently, the NAN proxy server 2020 can publish a service discovery frame to the NAN proxy client 2030. Subsequently, the NAN proxy client 2030 can establish a session with the NAN terminal 2010. In particular, according to the active subscribe type, on behalf of the NAN proxy client 2030, the NAN proxy server 2020 provides information on a service to the NAN terminal 2010 and receives a response from the NAN terminal 2010. Subsequently, as mentioned in the foregoing description, the NAN proxy server 2020 can deliver information received from the NAN terminal 2010 to the NAN proxy client 2030.

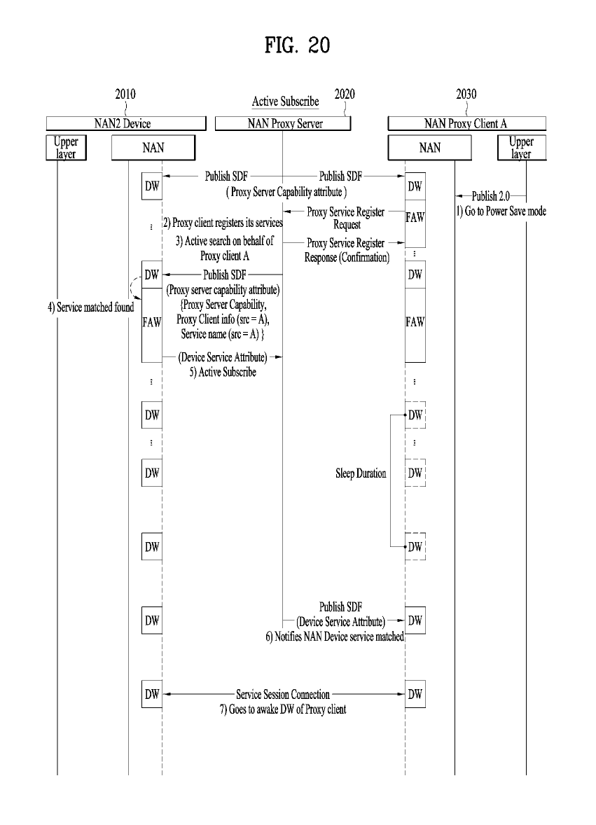

FIG. 21 is a flowchart for a method of providing a proxy service via a proxy server.

A NAN proxy client can register at a NAN proxy server [S2110]. In this case, as mentioned earlier in FIGS. 11 to 20, a procedure for registering the NAN proxy client at the NAN proxy server can be performed. In this case, for example, if the NAN proxy client registers at the NAN proxy server, the NAN proxy client can awake in a discovery window of a certain interval only. By doing so, it may be able to reduce power consumption of the NAN proxy client.

Subsequently, the NAN proxy server can perform discovery on a first service on behalf of the NAN proxy client [S2120]. In this case, as mentioned earlier in FIGS. 11 to 20, the NAN proxy server can perform a publish/subscribe function on behalf of the NAN proxy client. In particular, the discovery may correspond to the publish/subscribe function. And, the first service may correspond to a proxy service. More specifically, the first service may correspond to a service supported by the NAN proxy client. In this case, the NAN proxy client can provide information on a service to be used by the NAN proxy client to the NAN proxy server in the process of being registered at the NAN proxy server. By doing so, the NAN proxy server can perform a procedure for performing communication on behalf of the NAN proxy client. By doing so, it may be able to reduce power consumption of the NAN proxy client.

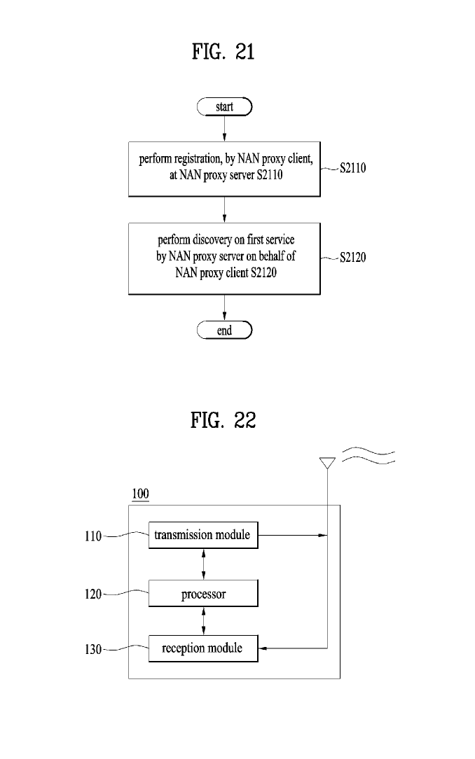

FIG. 22 is a block diagram for a terminal device.

A terminal device may correspond to a NAN terminal. In this case, for example, the NAN terminal may correspond to a terminal playing a role of a NAN proxy server. And, the NAN terminal may correspond to a terminal playing a role of a NAN proxy client. And, the NAN terminal may correspond to a terminal performing discovery with the NAN proxy server.

In this case, the terminal device 100 can include a transmission module 110 configured to transmit a radio signal, a reception module 130 configured to receive a radio signal, and a processor 120 configured to control the transmission module 110 and the reception module 130. In this case, the terminal 100 can perform communication with an external device using the transmission module 110 and the reception module 130. In this case, the external device may correspond to a different terminal device. And, the external device may correspond to a base station. In particular, the external device may correspond to a device capable of performing communication with the terminal device 100, by which the present invention may be non-limited. The terminal device 100 can transmit and receive digital data such as contents using the transmission module 110 and the reception module 130. And, the terminal device 100 can exchange a beacon frame, a service discovery frame, and the like using the transmission module 110 and the reception module 130, by which the present invention may be non-limited. In particular, the terminal device 100 performs communication using the transmission module 110 and the reception module 130 and may be able to exchange information with an external device.

According to one embodiment of the present specification, the processor 120 of the terminal device 100 can perform registration of a NAN proxy client. And, the processor 120 can perform discovery on a first service on behalf of the NAN proxy client using the transmission module 110 and the reception module 130. In this case, information on the first service is delivered to the NAN proxy server in the process of performing registration and can be used for the discovery. And, as mentioned in the foregoing description, the discovery can be performed based on a discovery type.

The embodiments of the present invention may be achieved by various means, for example, hardware, firmware, software, or a combination thereof.

In a hardware configuration, the methods according to exemplary embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

And, both an apparatus invention and a method invention are explained in the present specification and the explanation on both of the inventions can be complementally applied, if necessary.

### INDUSTRIAL APPLICABILITY

Although the present invention is explained under the assumption that the present invention is applied to a NAN wireless communication system, by which the present invention may be non-limited. The present invention can be applied to various wireless systems using the same scheme.

1. A method of performing discovery performed by a NAN (neighbor awareness networking) proxy server in a wireless communication system, the method comprising:
performing registration, by a NAN proxy client, at the NAN proxy server; and
performing discovery, by the NAN proxy server, on a first service on behalf of the NAN proxy client,
wherein information on the first service is delivered to the NAN proxy server in a process of performing the registration and is used for the discovery and wherein the discovery is performed based on a discovery type.

2. The method of claim 1,
wherein the information on the first service comprises at least one of name information of the first service and device information of the NAN proxy client.

3. The method of claim 2,
wherein the NAN proxy server transmits a publish message containing a service discovery frame to a first NAN terminal when the discovery type corresponds to a first type.

4. The method of claim 3,
wherein the information on the first service is contained in the service discovery frame.

5. The method of claim 4,
wherein the first NAN terminal directly establishes a session with the NAN proxy client using the information on the first service contained in the service discovery frame when the publish type corresponds to a first type.

6. The method of claim 4,
wherein the NAN proxy server receives a subscribe message containing attribute information on the first NAN terminal from the first NAN terminal when the publish type corresponds to a second type.

7. The method of claim 6,
wherein a publish message containing the attribute information on the first NAN terminal is transmitted to the NAN proxy client when the NAN proxy server receives the subscribe message.

8. The method of claim 7,
wherein the publish message containing the attribute information on the first NAN terminal is exchanged in a discovery window in which the NAN proxy client is awaked.

9. The method of claim 2,
wherein the NAN proxy server receives a subscribe message containing attribute information on the first NAN terminal from the first NAN terminal when the discovery type corresponds to a second type.

10. The method of claim 9,
wherein the attribute information on the first NAN terminal comprises information on a second service.

11. The method of claim 10,
wherein the second service corresponds to a service to be used by the first NAN terminal.

12. The method of claim 11,
wherein the NAN proxy server transmits a publish message containing a service discovery frame to the first NAN terminal in response to the subscribe message when a subscribe type corresponds to a first type, and
wherein the publish message is transmitted to the first NAN terminal only when the first service is matched with the second service.

13. The method of claim 11,
wherein the NAN proxy server transmits a publish message containing a service discovery frame to the NAN proxy client when a subscribe type corresponds to a second type, and
wherein the publish message is transmitted to the NAN client only when the first service is matched with the second service.

14. A NAN (neighbor awareness networking) proxy server in a wireless communication system, comprising:
a reception module configured to receive information from an external device;
a transmission module configured to transmit information to an external device; and
a processor configured to control the reception module and the transmission module,
wherein the processor is further configured to:
perform registration of a NAN proxy client,
perform discovery on a first service on behalf of the NAN proxy client,
wherein information on the first service is delivered to the NAN proxy server in a process of performing the registration and is used for the discovery and wherein the discovery is performed based on a discovery type.

15. The NAN proxy server of claim 14,
wherein the information on the first service comprises at least one of name information of the first service and device information of the NAN proxy client.
